(19) United States
(12) Patent Application Publication
(10) Pub. No.: US 2020/0265733 A1
(43) Pub. Date: Aug. 20, 2020

(54) LIVE ADAPTIVE TRAINING IN A PRODUCTION SYSTEM

(71) Applicant: Amazon Technologies, Inc., Seattle, WA (US)

(72) Inventors: Jessica Emily Arfaa, Bellevue, WA (US); Ashley Brooke Caringer, Issaquah, WA (US); Vadim Bachmutsky, Richmond Hill (CA); Eric C. Adams, Kirkland, WA (US); Dylan Charles Kauling, Toronto (CA); Austin Meredith, Everett, WA (US); Anirudhan Mukundan, Thornhill (CA); Christopher J. Part, New Berlin, WI (US); Alexander HL Poon, Seattle, WA (US); William Santo, Waterloo (CA); John Patrick Stewart, Rancho Cucamonga, CA (US); Alberto Zubiri, Richmond Hill (CA)

(21) Appl. No.: 16/276,262

(22) Filed: Feb. 14, 2019

(51) Int. Cl. G09B 5/02; G06Q 10/08

(52) U.S. Cl. CPC G09B 5/02; G09B 7/08; G06Q 10/087

(57) ABSTRACT

Techniques for live adaptive training in a production system are described. In an example, a training application executed on a workstation receives, based at least in part on an identifier of a user of the workstation, a training module and a trigger rule to present the training module. The training application exchanges, with a workstation application executed on the workstation, data about an event determined by the workstation application. The training application also determines a match between the trigger rule and the event. Based at least in part on the match, the training application initiates a presentation of the training module. In a further example, when the training module is presented, a transition rule may be used by the training application, based on an event from the workstation application, to determine a next training segment from the training module to present.

### BACKGROUND

Modern inventory systems, such as those in mail order warehouses and supply chain distribution centers, often utilize complex computing systems, such as robotic systems, to manage, handle, and convey items and/or storage containers within a workspace, increasing the productivity and safety of workers tasked with stowing or picking inventory to/from inventory storage. Learning to operate such computing systems takes time, and typically includes both offline training for workers before they enter a workspace as well as on-the-job training provided by more experienced workers, typically on a task-by-task basis as the less experienced worker begins to undertake new tasks.

### BRIEF DESCRIPTION OF THE DRAWINGS

Various embodiments in accordance with the present disclosure will be described with reference to the drawings, in which:

FIG. 1 illustrates updates to a user interface of a workstation based on live adaptive training, in accordance with at least one embodiment;

FIG. 2 illustrates a user interface of a workstation based on introductory training, in accordance with at least one embodiment;

FIG. 3 illustrates a user interface of a workstation based on training for functionalities of the workstation, in accordance with at least one embodiment;

FIG. 4 illustrates a user interface of a workstation based on training for inventory actions, in accordance with at least one embodiment;

FIG. 5 illustrates a computer network architecture for providing live adaptive training, in accordance with at least one embodiment;

FIG. 6 illustrates an architecture of a workstation for providing live adaptive training, in accordance with at least one embodiment;

FIG. 7 illustrates a sequence diagram for receiving training modules based on a user and a workstation, in accordance with at least one embodiment;

FIG. 8 illustrates a sequence diagram for introductory training, in accordance with at least one embodiment;

FIG. 9 illustrates a sequence diagram for a training related to a task or an action of the task, in accordance with at least on embodiment;

FIG. 10 illustrates a sequence diagram for a training related to a task or an action of the task, in accordance with at least one embodiment;

FIG. 11 illustrates an example flow for live adaptive training, in accordance with at least one embodiment;

FIG. 12 illustrates an example flow for providing training modules, in accordance with at least one embodiment;

FIG. 13 illustrates another example flow for live adaptive training, in accordance with at least one embodiment;

FIG. 14 illustrates an example environment suitable for implementing aspects of an inventory system, in accordance with at least one embodiment; and

FIG. 15 illustrates a computer architecture diagram showing an example computer architecture, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, live adaptive training in a production system. “Live” may refer to the capability of completing training on a computer system of the production system with production-related actions, while this computer system need not be taken offline or removed from being an available and active component of the production system. “Adaptive” may refer to the capability to refine the training based on a user of the computer system, the computer system itself, and/or the production-related actions to be performed by the user in association with the computer system.

In an example, the production system may be an inventory system that includes a workstation, among other computer systems. A user may attend the workstation to receive and perform instructions related to stowing items into inventory, picking items from inventory for downstream handling, or other inventory management operations. In addition to any offline training that might be provided to users, live adaptive training may also be provided to the user via the workstation. In particular, training modules may be sequenced for presentation at the workstation, where the sequence may be based at least in part on an identifier of the user, a training history of the user for performing inventory-related actions, and/or tasks queued for the user. An identifier of the workstation and/or a type thereof, a determination of the components thereof, other contextual information (e.g., preferred language, location, etc.) may be used to identify particular versions of the training modules that should be included in the sequence. Each training module may also include multiple segments, and the selection, completion, and navigation between the segments may be adapted based at least in part on signals from the workstation. These signals may indicate inventory-related tasks that the user is about to perform and/or whether a completed or incomplete task was performed improperly relative to safety or other relevant measures. In this way, the workstation may initiate the presentation of the training modules sequentially based at least in part on the training history and need of the user and the expected inventory-related tasks they are being asked to complete. While presenting one of the training modules, the workstation may select and present a particular segment of this module based at least in part on an upcoming inventory-related task that the user has not be trained on yet and/or on how the user performed given a previous inventory-related action and the related training.

To illustrate, consider an example of an inventory handling task that includes picking an item from an inventory storage bin and scanning the item with a conventional, peripheral barcode scanner device forming a component of the workstation. The user may be a first time user of the workstation and/or may have not performed this action before. Upon a user login to the workstation, a sequence of training modules may be identified. This sequence may include a first training module that generally introduces the type of work, a second training module that introduces the functionalities of the workstation, and a third training module that is specific to picking items. In turn, the last module may include segments specific to identifying a container within the inventory storage bind and scanning the container's barcode and to identifying an item from the container and scanning the item's barcode. The workstation may execute a pick application configured to present pick instructions to the user and to receive the user interactions related to item picking. The workstation may also execute a training application configured to interface with the pick application and to present the training modules. When the user first logs in, the training application may present the first training module in an overlay that covers the graphical user interface (GUI) of the pick application. Thereafter, the training application may present the second training module by exposing the GUI action buttons of the pick application and presenting the training segments about each of these buttons. Once that aspect of the training is complete, the training application may receive an event from the pick application that an item should be picked up from a container or may send an event to the pick application indicating that the user is about to be training on such an action. In the first case, the training application may determine that the user has not been trained yet for that type of action. In the second case, the pick application may communicate with one or more other components of the inventory system to move a container of items to the workstation for an item pick by the user. In both cases, the training application may launch the third training module and present the segment about identifying the container and scanning its barcode. Upon a scan of the proper barcode, the pick application may send an event to the training application that the proper container was identified. In response, the training application may present the training segment about identifying the item and scanning its barcode. Once that presentation is complete, the item may be shown in the GUI of the pick application. Upon a scan of the proper barcode, the pick application may send an event to the training application that the proper item was scanned. In response, the training application may conclude this training module. However, if throughout this training, an error occurs, the third training module can be adapted to address the error. For instance, if the incorrect container barcode was scanned, the training application may present again the first segment or may present another segment having additional instructions about how the container should be identified.

In the interest of clarity of explanation, embodiments of the present disclosure may be described in connection with an inventory system and specific inventory actions, such as picking items. However, the embodiments are not limited to such systems nor to such inventory actions. Instead, the embodiments may similarly apply to any trainable action and to any production system. In particular, a production system may include, for instance, a workstation operable by a user to interface and/or interact with other computer systems of the production system. An action related to the interfacing and/or interaction may be performed at the workstation, via a peripheral device of the workstation, and/or at a local system in communication with the workstation. Live adaptive training about the action may be presented to the user at the workstation. For example, performing the action may rely on a workstation application executed by the workstation, where this workstation application may be configured to present instructions to and/or receive interactions from the user about the action, and provide the needed data to the applicable computer systems of the production system. A training application may also be executed at the workstation and may interface with the workstation application. This training application may be configured to present training modules while the workstation is in use and to adapt the training modules based at least in part on data from the workstation application about the action and/or how well the user is performing the action.

Embodiments of the present disclosure provide many technological advantages. In an example, the overall performance (e.g., throughput) of a production system may be improved because a workstation need not be taken offline. Instead, the workstation may still be operated to perform actions of the production system (e.g., production actions), while the training about the production actions may be provided to the user in real-time. In another example, the training may be more effective than traditional offline or classroom training because the user may be trained with actual production actions and on actual workstations. In yet another example, the training may be more computationally efficient (e.g., memory space, software coding, computer-readable instructions processing) and scalable regardless of how complex the production system becomes. In particular, training modules for production actions, user training profiles, and workstation profiles may be maintained at a training computer system. Upon a user login on a workstation, the profile may be checked to construct on the fly a sequence of training modules from the available modules and format them according to a format supported by the workstation (e.g., based on the workstation's operating system (OS), display size, and the like) and/or applicable to contextual information about the user, the workstation, the inventory system, and/or the production system. Such an architecture may avoid the complexity of having to define and code different training modules for the different production actions, users, and workstations.

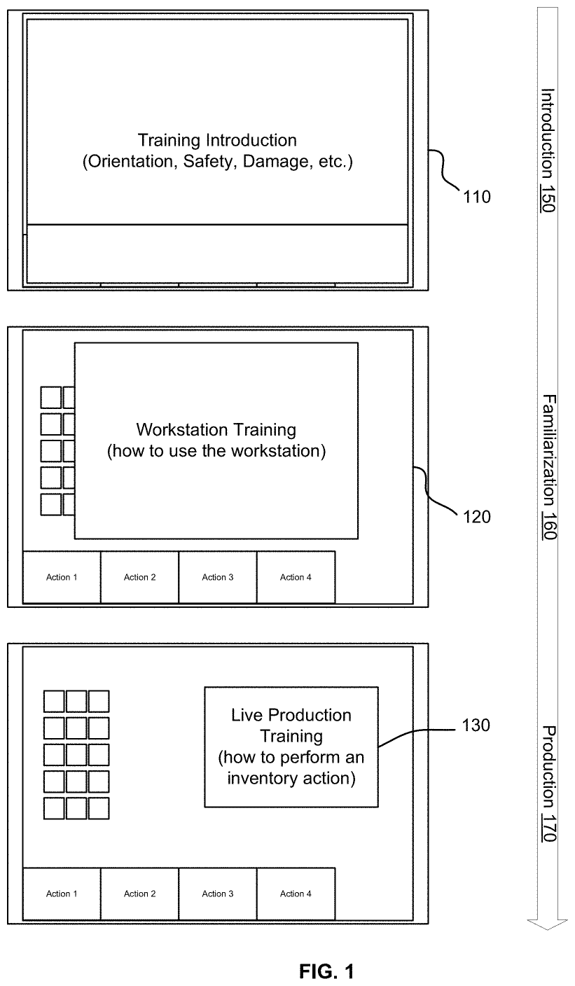

FIG. 1 illustrates updates to a user interface of a workstation based on live adaptive training, in accordance with at least one embodiment. The workstation may include a display 110 as the user interface. The workstation may execute a workstation application and a training application, each of which may have a workstation application GUI 120 and a training application GUI 130 presented on the display 110. The user may operate the workstation and use the workstation application to perform inventory actions by initiating and/or executing such actions via the workstation application GUI 120. In comparison, the training application may provide adaptive and live training to the user via the training application GUI 130 and based on an interface with the workstation application. FIG. 1 illustrates the adaptive and live training in multiple phases including an introduction phase 150, a familiarization phase 160, and a production phase 170. The phases are described herein to indicate particular modules that can be provided to the user. These modules can represent a training course. The training course can deliver, in each phase, one or more modules in a sequence, and a sequence of multiple modules across the phases.

In the introduction phase 150, the user may have not received training yet or may be in need of new or updated training for being, for instance, a first time user of the workstation and/or of an inventory management facility that includes the workstation. This facility may be a structure to manage an inventory including, for instance, to receive, process, and/or ship items. A storage facility (e.g. a fulfillment center or a warehouse) and a sortation facility may be examples of the inventory management facility. Accordingly, in the introduction phase 150, one or more introduction training modules may be presented. These modules may provide a general orientation to the user, explain how to safely operate the workstation and/or interact within the surrounding space and/or with other interfacing systems, introduce the user to knowing how to detect and handle damaged items, and other general introductory training. Accordingly in this phase 150, the training application may present the introduction training modules in an overlay that covers entirely or almost entirely the workstation application GUI 120. FIG. 1 illustrates this approach by showing the training application GUI 130 being presented over and obstructing the workstation application GUI 120.

In the familiarization phase 160, the user may have successfully completed the introductory training (e.g., viewed the introduction training modules and/or correctly answered any questions). At this point, the training may be adapted to familiarize the user with the functionalities of the workstation application. For example, the workstation application GUI 120 may include multiple action buttons, each to initiate and/or execute a particular inventory action. In this phase 160, one or more familiarization training modules may be available to explain the functionalities of these buttons. Accordingly, the training application may present these training modules in a reduced size overlay that exposes at least some or all of the action buttons of the workstation application GUI 120. FIG. 1 illustrates this approach by showing the training application GUI 130 having a smaller size in the familiarization phase 160, allowing the action buttons at the bottom of the workstation application GUI 120 to become visible to the user.

In the production phase 170, the user has successfully completed the familiarization training (e.g., viewed the familiarization training modules, correctly answered any questions, and/or correctly interacted with the action buttons). At this point, the user may start using the workstation to perform actual inventory actions. In this phase 170, one or more inventory action training modules may be available to explain how to perform the inventory actions in real-time and in context (e.g., based on triggers from a production system and/or interactions with the workstation). Accordingly, the training application may present these training modules in a further reduced size overlay that further displays functionalities of the workstation application GUI 120. FIG. 1 illustrates this approach by showing the training application GUI 130 having the smallest size in the production phase 170, allowing the action buttons and presentation area to the left of the workstation application GUI 120 to become visible to the user.

In this phase 170 also, the progress within an inventory action training module and among multiples of such modules may depend on the performance of the user with respect to the inventory action at hand. In particular, the training application may exchange data with the workstation application about the performance. Each training module may include a set of rules to identify when the training module should be launched. Based on a particular task to be performed (e.g., reporting a damaged item), the training application may select and launch the relevant training module (e.g., training about damage reporting). In addition, based on the data exchanged with the workstation application indicating a particular event (e.g., missing information about the damage), a particular segment from the training module may be selected and presented (e.g., one about inputting the data damage information). In other words, in the production phase 170, the workstation application may present instructions about particular inventory actions and support functionalities to initiate, control, and/or perform such actions. In parallel, the training application may exchange data about these actions with the workstation application to then adapt the training content and/or the overlay of the training application GUI 130.

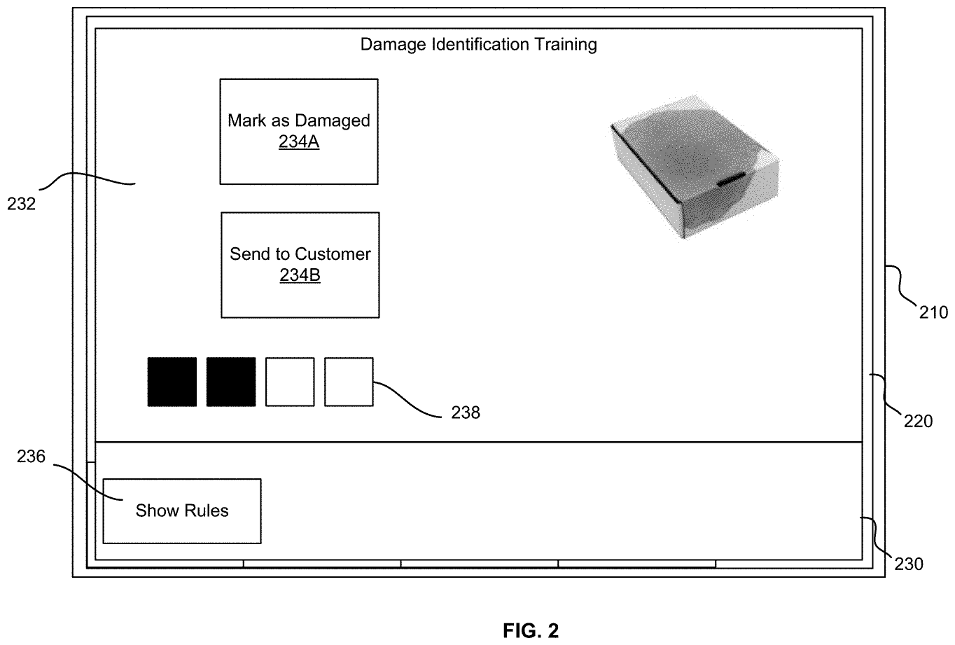

FIG. 2 illustrates a user interface of a workstation based on introductory training, in accordance with at least one embodiment. The introductory training may correspond to an introduction phase, such as the introduction phase 150 of FIG. 1. In an example, a training application GUI 230 may be overlaid over a workstation application GUI 220 on a display 210 of the workstation, where the training application GUI 230 may cover entirely or almost entirely the workstation application GUI 220. Content 232 presented in the training application GUI 230 may be available from one or more training modules. As presented, the content 232 may provide a general introduction and may be interactive.

For example, the content 232 may be organized in a sequence of segments (e.g., pages, slides, or the like) describing different training topics (e.g., training for recognizing damages). The content 232 may also include one or more navigation buttons, such as “next,” “previous,” and the like (not shown). Upon a user selection of a navigation button, the presentation of the content 232 may proceed forward or backward as applicable.

Further, the content 232 may include questions and answers to help and/or test the user's training knowledge. As illustrated in FIG. 2, one of the segments may show an image of a damaged item and may ask the user to select whether the item should be marked as damaged by selecting a first button 234A or the item is not damaged and could be sent to a customer by selecting a second button 234B. The navigation between the training segments may depend on the user properly answering the question.

To provide additional help, the content 232 may also include a help section. For instance, a show rules button 236 may be presented and may be selectable to present a segment about the rules for determining whether the item is damaged or not.

The content 232 may also indicate the progress of the user through an introduction training module. For instance, and as illustrated in FIG. 2, the content 232 may include progress buttons 238 showing that the user has been through two segments (as illustrated with the two solid boxes) and has two remaining segments (as illustrated with the two empty boxes).

Interactions of the user with the content 232, such as with the navigation buttons, answer buttons, help buttons, and the like may be recorded by the training application. The training application may send data about such interactions and about completion(s) of introduction training module(s) to a training computer system for updates to a training profile of the user.

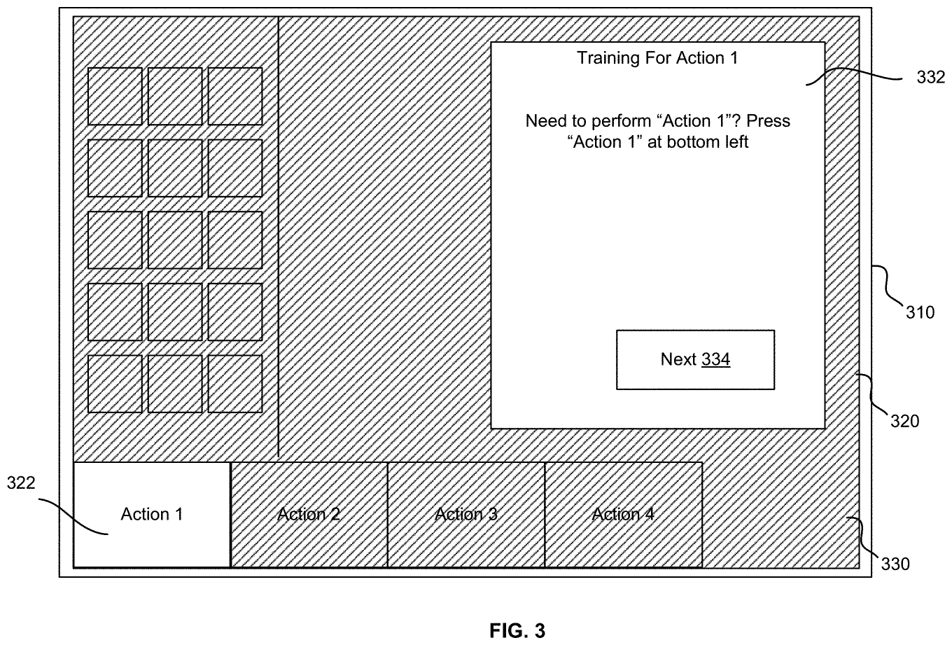

FIG. 3 illustrates a user interface of a workstation based on training for functionalities of the workstation, in accordance with at least on embodiment. This training may correspond to a familiarization phase, such as the familiarization phase 160 of FIG. 1. In an example, a training application GUI 330 may be overlaid over a workstation application GUI 320 on a display 310 of the workstation, where the training application GUI 330 may adaptively expose action buttons of the workstation application GUI 320.

Particularly, the workstation application GUI 320 may include multiple action buttons that support corresponding inventory actions. FIG. 3 illustrates four of such buttons at the bottom of the workstation application GUI 320, although other number and placement may be possible.

A familiarization training module may be available to familiarize the user with these buttons. Each segment of this module may correspond to one of the action buttons and their presentation may be organized in a sequence. The training application GUI 330 may present each segment in an overlay that hides (e.g., completely or partially obstructs) the workstation application GUI 320, except for the corresponding action button. This overlay may include a window 332 that presents the content of the segment detailing the functionality of the corresponding action button. The window 332 may include one or more navigation buttons 334 to move between the content. In addition or alternative to the navigation button(s) 334, the overlay may extend over the corresponding action button, where this overlapping portion of the overlay (e.g., the portion over the corresponding action button) may be transparent and selectable to act as a navigation button (e.g., a “next” button). In this way, the window 332 may instruct the user to click on the corresponding action button that is visible through the transparent portion and this click may be used as a navigation command.

In the illustrative example of FIG. 3, the window 332 may present training that familiarizes the user with the “Action 1” button 322. The “Action 1” button 322 is exposed (e.g., either not covered with the overlay of the training application GUI 330 or, if there is an overlapping portion, this portion is transparent and can be highlighted). Accordingly, content of this window 332 may explain that, to perform this action, the bottom left button 322 should be pressed. Upon a selection of the navigation button 334, the next segment about the next action button may be presented, where this button may become visible and the “Action 1” button may be hidden.

Here also, interactions of the user with the content presented at the training application GUI 330 may be recorded by the training application. The training application may send data about such interactions and about completion(s) of familiarization training module(s) to a training computer system for updates to a training profile of the user.

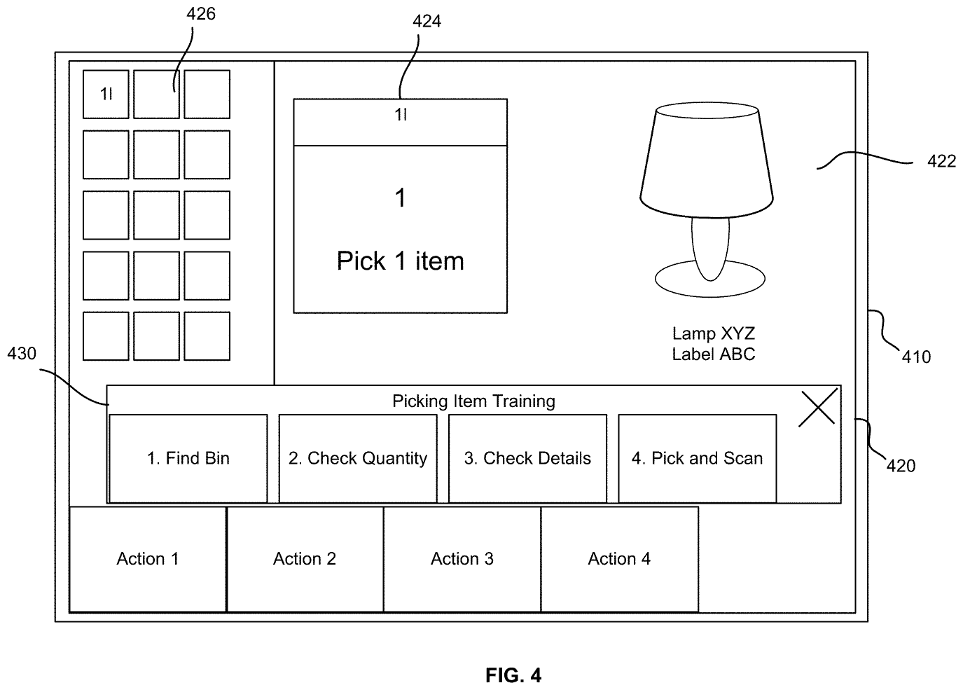

FIG. 4 illustrates a user interface of a workstation based on training for inventory actions, in accordance with at least one embodiment. This training may correspond to a production phase, such as the production phase 170 of FIG. 1. In an example, a training application GUI 430 may be overlaid over a workstation application GUI 420 on a display 410 of the workstation. The training application GUI 430 may present training content in an overlay that obstructs a small portion of the workstation application GUI 420 such that the display 410 may be primarily occupied by the workstation application GUI 420. In addition, the training content may depend on a data exchange between the training application and the workstation application.

In the illustration of FIG. 4, the user may be trained for picking an item because the user may have not been trained before on this type of inventory action, for needing a refresher training, or because the inventory action may rely on a new type of container or a new type of inventory holder (e.g., one that includes multiple bins) that the user may have not encountered before. Accordingly, the workstation application 420 may include multiple visible portions. In a first portion 422, the item to be picked may be identified. This item may be an actually inventoried item stored in a particular bin (or a particular container). For instance, the first portion 422 may show an image of what the item looks like and includes a textual description of the item. In a second portion 424, the quantity of the item to be picked and its location may be identified. For instance, this second portion 424 may instruct the user to pick one item from bin “11” (e.g., top left shelf). In a third portion 426, the location of the item may be shown. For instance, this third portion 426 may show the bin location of the item in the inventory holder. This information about the item, quantity, and location may be available from an inventory action associated with an actual customer order for the particular quantity of the item and may be provided to the workstation application from a management system that manages the fulfillment of such customer orders.

Upon a determination for a need to train the user on picking items, the training application GUI 430 may be overlaid over a portion of the workstation GUI 420. The training application GUI 430 may present a training module specific to picking items (e.g., an item pick training module). This training module may include multiple segments organized in a sequence, one for finding the item's location, one for checking the quantity, one for checking the details of the item, and one for picking and scanning the item.

The training application may automatically initiate the presentation of the item pick training module based on the sequence or may be waiting for a user selection of one of the segments. While the training is being presented, functionalities of the workstation GUI 420 may not be available to the user, even though certain portions of this GUI 420 may remain visible.

In an example, the segment for finding the item location may be presented in the training application GUI 430 in the same overlay or in a new overlay. Once the presentation of that segment is complete, the segment for checking the quantity may be presented next, followed by the presentation of the segment for checking details, and then by the presentation of the pick and scan segment. At this point, the workstation application GUI 420 may be operational again for the item pick.

The user may perform an item pick as instructed by the workstation application GUI 420. In response, the workstation application may receive data from underlying systems about the bin that was reached, the container that was scanned, the item that was scanned, and/or the item quantity that was scanned. The workstation may compare this data to its local information about the item, location, and quantity and determine whether the item pick was performed properly. Information about the performance may be sent to the training application as event data. For instance, the event data may identify whether the correct bin was reached, the correct container was scanned, the correct item was scanned, and/or the correct item quantity was scanned. If the event data indicates that the item pick was properly performed, the training application may complete the presentation of the item pick training module. However, if the event data indicates that performance of any of the actions failed (e.g., incorrect bin reached, incorrect container scanned, incorrect item scanned, incorrect item quantity scanned), the training application may present the corresponding segment from the item pick training module again, a new segment with additional training about the failed action, or a new training module with such additional training content.

Here also, interactions of the user with the content presented at the training application GUI 430 and the event data may be recorded by the training application. The training application may send data about such interactions, the event data, and data about completion(s) of training module(s) to a training computer system for updates to a training profile of the user.

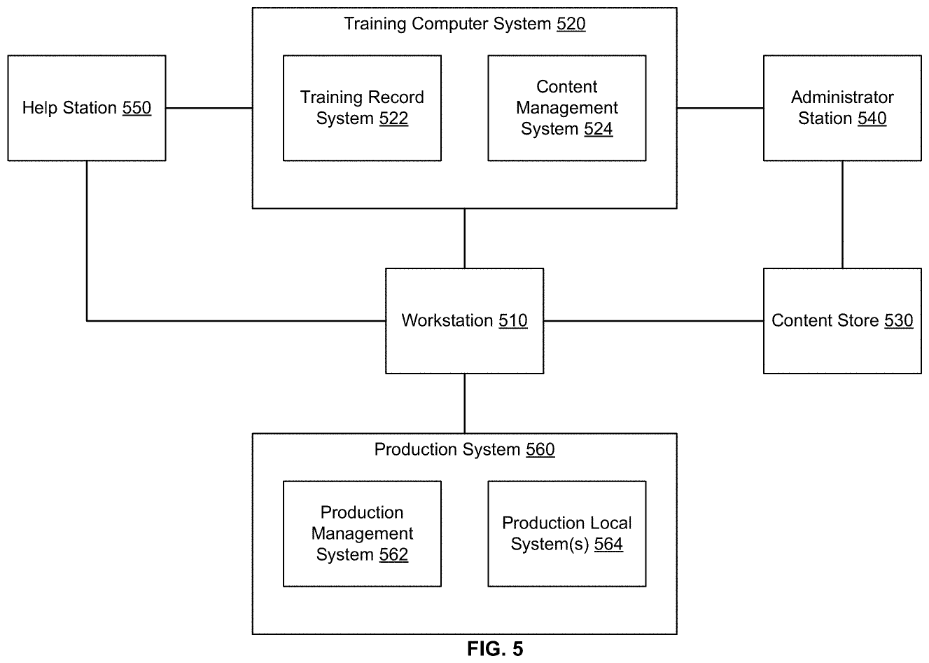

The GUIs in FIGS. 1-4 are provided for illustrative purposes. Other layouts and functionalities may be supported by such GUIs. For example, any of the training application GUIs may include an exit option to exit the training GUI to a workstation application GUI. For instance, this exit option can be presented in a dropdown menu that allows the user to hide the training application at any time. In another illustration, the exit option may be automatically invoked (e.g., based on an API call) to hide the training material at particular times or based on particular user interactions. Furthermore, any of the workstation application GUIs may include a training option to present the training application GUI. Any of such GUIs may also include a call option to request help from a training assistant. In addition, other GUIs may be presented to train users on new processes available at workstations and/or on changes to existing workstations and/or input and output peripheral devices interfacing with such workstations. Generally, training modules may be defined for the processes and/or changes and can be presented in such GUIs in an adaptive and live approach as described herein. In addition, the training application has an application programming interface (API) configured to receive a definition of a content author about a cutout in a canvas presented, by the training application, in an overlay over a GUI of the workstation application. For instance, and referring to FIGS. 4 and 5, the API is usable to the content author to create cutouts in the underlying canvas and make the underlying workstation applicable GUI available to the user on particular training modules and/or training segments.

FIG. 5 illustrates a computer network architecture for providing live adaptive training, in accordance with at least one embodiment. As illustrated, the computer network architecture may include a workstation 510, a training computer system 520, a content store 530, and administrator station 540, a help station 550, and a production system 560. Such systems may be communicatively coupled over one or more data networks and may exchange data to provide live and adaptive training to a user at the workstation in connection with production actions related to the production system 560.

In an example, the workstation 510 may represent a station operable to a user to perform various inventory-related actions and located in an inventory management facility. The station may include a workstation control system to manage how the user performs the actions. The station may also include a space for receiving items, containers, and/or inventory holders that may be moved to and from the station via mobile drive units and/or conveyor belts. In addition, the station may include a set of input and output devices to interact with the workstation control system and or within the space, and a set of tools (e.g. racks, ladders, etc.) and sensors (e.g., optical sensors, light sensors, time of flight sensors, etc.) to track the interactions and/or items, containers, and inventory holders.

In an illustration, the workstation control system may be a computer system such as a thin client a portable computing device, or any other computer suitable for instructing the user about the production actions and for receiving user interactions to initiate, control, perform such actions, and/or report. In the context of an inventory system, the workstation control system may include one or more processors and one or more memories (e.g., non-transitory computer-readable storage media) storing computer-readable instructions executable by the one or more processors. Upon execution of the computer-readable instructions, the workstation control system may receive, from the production system 560, instructions about inventory actions scheduled to be performed to fulfill customer demand for items available from or to be stored in the inventory management facility. Information about such actions may be presented in workstation application GUIs of the workstation control system to trigger the relevant user interactions. In particular, the workstation control system may also include a display, such as a touchscreen, and input and output peripheral devices (e.g., a keypad) to perform the user interactions.

Other input and output devices can also interface with the workstation control system to perform certain user interactions related to the operations of the workstation 510 and/or the production system 560. These devices may include, for instance, a scanner, action buttons, and a stop button. A scanner may be a handled device or may be affixed in the space of the workstation 510 and may be usable to scan an item, a container, a label, and the like. The scanned data may be sent to the workstation computer system. An action button may be affixed on a container, in a bin of an inventory holder, or at a location in the space and may be operational to trigger or report an action. For instance, an action button on a container may be pushed to indicate that the container was selected and this selection may be sent to the workstation control system. The stop button may be operable to stop the user's operations at the workstation 510 and/or any automated processes available for the workstation 510 (e.g., to stop incoming inventory holders moved by mobile drive units, to stop a conveyor belt, etc.). by triggering this button, the production system 560 may halt actions scheduled for the workstation 510.

The training computer system 520 may represent a learning management system (LM)S that manages the training content to be provided to the user operating the workstation 510. For example, upon a user login on the workstation 510 (e.g., via a badge scan of the user), the training computer system 520 may receive an identifier of the user from the workstation 510 and may identify the workstation 510 itself (e.g., based on an internet protocol (IP) address).

The training computer system 520 may include a training record system 522 and a content management system 524. The training record system 522 may store a training profile of the user and, optionally, a profile of the workstation. The training profile may include a training transcript, identifying a history of the training provided to the user, including successfully completed training and incomplete training. This history may be stored at different levels of granularity. For instance, the history may be specific to a production task level and/or to a workstation level. In an example, the history may be stored following the industry-standard xAPI specification. This standard records module-level actions such as launched, completed, passed, and failed, as well as “experienced” actions about viewing segments in a module, and user interactions with any quizzes during training. Other history data can be sent in additional xAPI statements. The training record system 522 may update the training profile based on interaction and training completion data received from the workstation 510. The profile of the workstation may 510 identify the workstation computing configuration (e.g., the application(s) available on the workstation, the workstation's OS, display size, and/or location, an identifier of the inventory management facility storing the workstation 510, the inventory management facility's location, etc.) and the production tasks that can be performed with the workstation.

Based on the identifier of the user and the identifier of the workstation 510, the training record system 522 may access the respective profiles and determine profile data (e.g., what training has been presented, the status of the training, the tasks supported by the workstation, the workstation computing configuration). The profile data can be used in different ways. In one example, the training record system 522 may host a rule engine that, based on the profile data, generates a sequence indicating training modules that should be provided next to the user and one or more production tasks that should trigger the presentation of one or more of such training modules. In this example, the content management system 524 may be configured to manage the training content and provide the correct training at runtime. In another example, the profile data is sent to the content management system. In this example, the content management system 524 may generate the sequence. In the context of an inventory management facility, these production tasks may be referred to as inventory triggers, whereby a presentation of a particular training module may be triggered upon a determination of a corresponding inventory trigger. The sequence and the task triggers may represent multiple training paths that a user may follow to receive training, where depending on real-time production data and real-time performance of the user, a specific training path may be presented to the user. This sequence may be sent to the workstation 510. Rather than including the actual training modules, the sequence may include identifiers and/or network addresses (e.g., uniform resource locators (URLs)) of these modules at the content store 530, such that the workstation 510 can retrieve the identified training modules from the data store 530. The identifiers may also be for tasks that need to be present to trigger the presentation of one or more of the training modules and/or training segments within such modules.

In an illustrative example, the training record system 522 returns information about a particular module to be delivered and the associated rules which a rule engine of a training application of the workstation 510 uses to determine when to present the particular module. This training application may receive an event from a workstation application of the workstation 510, and may match the event with the rules. When the match is determined, the training application may query the training computer system 522 (e.g., by using an API call identifying the particular module and indicating that it should be presented). Next, the training record system 522 may query the content system 524 to resolve to a particular URL where the training content in question resides.

The content store 530 may store various training content available to different users and applicable to different types of workstations (or workstation computing configurations) and production tasks. The training content may be indexed, by the content management system 524, to facilitate the generation of a particular sequence for a particular user, workstation, and/or production tasks. For example, training modules may be indexed with keywords identifying the type of production tasks to which these modules may be relevant. In addition, the content management system 524 may organize the training content into courses, each made up of sequences of training modules. Every training module may contain one or more module versions. At runtime, the content management system 524 may be queried to obtain a suitable module version for delivery based on runtime parameters (workstation type, location, language, hardware configuration, etc.). For instance, a training module may have a first version for a first workstation type and a first language and a second version for a second workstation type and a second language. At runtime, context data may be sent from the workstation 510 to the training computer system 520, where this data may indicate a type of the workstation and a preferred language of the user. Upon matching the type and preferred language with the first workstation type and the first language, the computer system may select the first version of the training module for the training of the user.

The administrator station 540 may include a computer system operable by a training administrator. In this way, the training administrator may have access to and be capable of updating, when proper permissions and privileged exist, training profiles of users, profiles of workstations, and rules usable to select training modules and training segments. The training administrator may also have access to the content store 530 and the content management system 524, where this access may enable the training administrator to upload, download, edit, index, and create training courses, modules, and segments. Multiple training courses may share one or more training modules. Sharing training modules may allow content authors (e.g., the training administrator) to not have to duplicate content. Moreover, the sharing may allow giving credit to the user for completing some parts of a training course instead of asking them to repeat a shared module anew. To achieve this, the training computer system 520 may join enrollment data with user transcript to determine which parts of a given course-enrollment the user may have already completed as part of another course (i.e. completed module).

The help station 550 may include a computer system operable by a training assistant. Upon a request for training help initiated by the user of the workstation 510 (e.g., via an event sent from the workstation 510, such as in an API call) or upon an automatic detection of needed training help, the help station 550 may alert the training assistant, and identify the user and the workstation 510. In addition, the help station 550 may provide the training assistant with access, when proper permissions and privileged exist, to training profiles of the user and the profile of the workstation from the training record system 522, such that this training assistant can quickly refine the provided help.

In an example, the help station 550 may allow the training assistant to enroll a trainee (e.g., a user of a workstation), individually or as part of a group, to receive training. Data about the enrollment may be sent to the training computer system 520 to trigger the training. For instance, the training assistant may input at the help station 550 an identifier of the trainee such as a via a badge scan, input on a keyboard or touchscreen, and/or import of trainee identifiers from a remote resource (e.g., for group enrollment). The training assistant may also input an identifier of the workstation upon which the trainee should be trained (e.g., the workstation 510). If a specific set of tasks should be included in the training, the training assistant may also identify the task(s) at the help station 550. The resulting data (e.g., trainee ID, workstation ID, and/or task ID) may be sent to the training computer system 520. In turn, the training computer system 520 may generate a sequence of training modules and of triggering tasks. This sequence may be sent, automatically or upon receiving the trainee ID from the identified workstation, to the identified workstation and that workstation may download and present the training modules automatically or upon receiving the trainee ID from the trainee.

In an example, the production system 560 may represent an inventory system that includes a production management system 562 and a production local system(s) 564. The production management system 562 may be a computer system, such as a central computer, configured to manage production tasks, such as inventory tasks, related to fulfilling customer demand. For example, based on the customer demand, the production management system 562 may generate instructions for inventorying items in and out of the inventory management facility, including tasks and schedules for storing items in particular locations, in particular storage types, and in particular quantities, tasks and schedules for picking a particular quantity of items from particular locations and storage types, tasks and schedules for particular users to user particular workstations to initiate and/or perform such storing and picking. Some of these instructions may be provided to the workstation 510 based on the login of the user and the scheduled tasks.

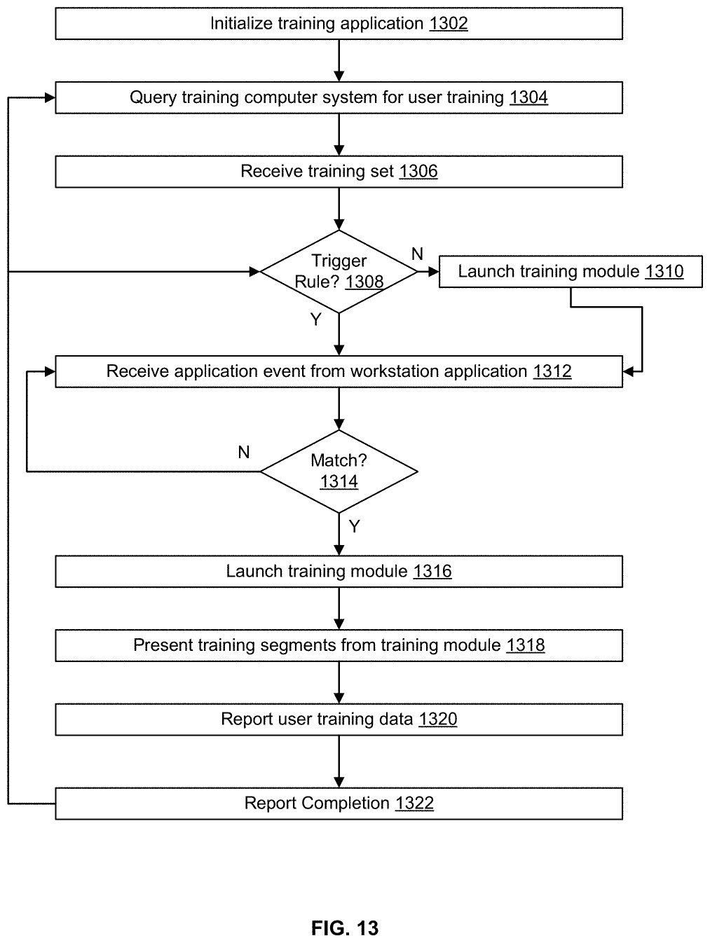

The production local system(s) 564 may include one or more computer systems that can be local to or become local to the workstation 510 and that the user may rely upon to perform the instructed production tasks. For example, these systems may include one or more inventory holders that contain bins and/or containers and sensors to track user reach in and out of the inventory holders, one or more mobile driver units that may transport the inventory holders to the workstation 510, one or more scanners to scan container and/or items, and the like. Further details about an example architecture of the production system 560 are illustrated in connection with FIG. 13.

Accordingly, upon the user login, the workstation 510 may receive a sequence indicating training modules from the training computer system 520, and may receive instructions about one or more production tasks from the production system 560. Given the sequence and the production tasks, the workstation 510 may retrieve the applicable training module from the content store 530 and launch the applicable training module for presentation to the user. As the training proceeds, progress may be reported to the training computer system 510 for further training sequences. In addition, as the production system 560 provides additional instructions, the workstation 510 may continuously adapt the training to these instructions. Help may be requested from the workstation 510 to the help station 550 to assist the user as needed.

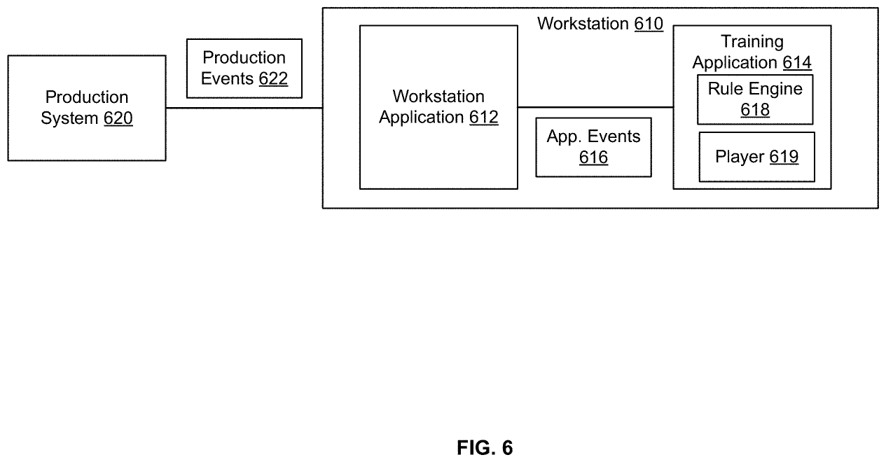

FIG. 6 illustrates an architecture of a workstation 610 for providing live adaptive training, in accordance with at least one embodiment. The workstation 610 may be an example of the workstation 510 of FIG. 5. As illustrated, the workstation 610 may interface (e.g., based on an application programming interface (APIs)) with a production system 620 and may execute a workstation application 612 and a training application 614 that, in turn, may interface (e.g., based on APIs) with each other. The interface with the production system 620 may drive the overall customization of the training to be specific to a particular inventory task. The interface between the two applications 612 and 614 may further refine this customization on the fly to be specific to how well the inventory task was performed based on the already presented training.

In an example, the interface between the workstation 610 and the production system 620 may facilitate the exchange of production events 622. The production events 622 may identify inventory tasks to be performed and the performance of such tasks. In one illustration, the production system 620 may have scheduled an inventory task to be performed at the workstation 610 by the user of the workstation 610. A production event may be sent from the production system 620 to the workstation 610 identifying the inventory task (e.g., providing instructions to the workstation application 612 about an item pick, location of the item, quantity of the item, etc.). In another illustration, the flow of production events may be in the opposite direction. In particular, the training application 614 may present a training module about a particular inventory task to the user. The workstation 610 may send an inventory event to the production system 620 requesting that this inventory task be scheduled for performance along with or upon completion of this training. In both illustrations, based on the user performing the inventory task, a related production event may be sent from production system 620 to the workstation 610 identifying performance-related data (e.g., a user reach into a bin of an inventory holder, a user scan of a container, a user scan of an item or item quantity, etc.). In an example, this data may be sent to the workstation application 612 and may remain transparent to the training application 614.

The interface between the two applications 612 and 614 may facilitate the exchange of application events 616. In the first illustration above, the workstation application 612 may send an application event to the training application 614 identifying the inventory task scheduled by the production system 620. In the second illustration above, the training application 614 may send an application event to the workstation application 612 identifying the inventory task for scheduling by the production system. In response, the workstation application 612 may send the relevant production event to the production system 620. In both illustrations, the workstation application 612 may send an application event identifying the success and/or failure of performing the inventory task or a certain aspect thereof (e.g., incorrect bin reach, scanned container is incorrect, scanned item or quantity is incorrect). The training application 614 may also send an application event identifying whether a particular training segment or training module was complete.

In an example, the workstation application 612 may be a production application executed on the workstation 610 and configured to perform certain inventory tasks. For instance, the workstation application 616 may be a pick application configured to instruct the user about item picks and for allowing the user to initiate, control, and/or perform such task picks.

In comparison, the training application 614 may be an application executed on the workstation 610 and configured to train the user. As illustrated, the training application 614 may include a rule engine 618 and a player 619. In an example, the player 619 stores the rule engine 618. The rule engine 618 may look up rules of a training module, where these rules may be stored in the training module, to determine whether the training module should be launched. Generally, a determination may be made to launch the training module upon a match between the rules and an inventory task that the user should perform, where information about this inventory task may be received in an event from the workstation application 612. When multiple training modules are available, the rule engine 618 may look up the different rules to select one or more of these modules depending on the match(es) and the player 619 may launch the selected training module(s). In addition, the rules of a training module may include transition rules to progress between training segments of the training module. Based on an application event received from the workstation application 612, the player 619 may determine a match with a transition rule and present a particular training segment of the training module. In an example, the player 619 may receive the application event over an API with the workstation application 612 and set JavaScript variables corresponding to the event. These variables may be used to identify the particular training segment. For instance, a transition rule may indicate that a training segment about checking an item quantity should be presented after the proper bin is found. Only if the application event indicates that the proper bin is found, the player 619 may present the training segment about checking the item quantity. Of course, transition rules may also relate to user interactions with the training module and/or the training segments. For instance, upon a user selecting a “next” option displayed in a training segment, a training rule may specify that a next training segment should be presented next.

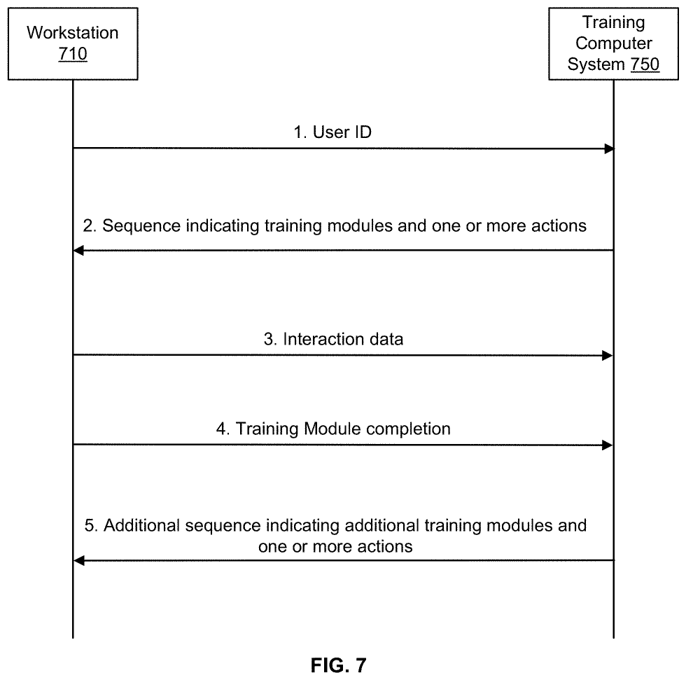

Interactions between the two applications 612 and 614 and with the production system 620 and other systems are further described herein next. In particular, FIGS. 7-10 illustrate sequence diagrams about these interactions.

FIG. 7 illustrates a sequence diagram for receiving training modules based on a user and a workstation, in accordance with at least one embodiment. In an example, a workstation 710 may interface with a training computer system 750. In particular, the workstation 710 may query the training computer system 750 via an API call for information regarding the training modules that should be delivered and the associated trigger rules for each one, as applicable. Based on the user, the training computer system 750 may identify at least one training module and the trigger rules to the workstation 710. Based on an inventory task that should be performed, the workstation 710 may determine a match with the trigger rules and launch the training module. Launching the training module may involve another API call to the training computer system 750 that, in turn, may perform validation and return a URL of the training content with an authentication token. The workstation 710 may present the training module based on the URL, and may report the progress of the training to the training computer system 750 based on the authentication token.

As illustrated, the workstation 710 may send a user identifier (ID) to the training computer system 750. For example, upon a badge scan of the user at the workstation 710, the workstation 710 may determine the user ID and may send this ID in a web request (e.g. in a data field of the web request) to the training computer system 750. In addition to including the user ID, the web request may include an ID of the workstation 710 (workstation ID). The workstation ID may be an internet protocol (IP) address of the workstation 710 in a header of the web request or some other identifier included in the data field. Furthermore, the workstation 710 may send contextual data, such as contextual data type of the workstation, location, identifier of the inventory management system that includes the workstation 710, etc.

Next, the training computer system 750 may identify the user based on the user ID and the workstation 710. In response, the training computer system 750 may access a training profile of the user, course enrollment of the user, a profile of the workstation 750, and/or any scheduled inventory tasks to be performed by the user on the workstation 750. Based on this data, the training computer system 750 may generate and send a first set of training modules and their respective trigger rules to the workstation 710.

The workstation 750 may select and present one or more of the training modules, as applicable. The user may interact with the presented training content and/or with the workstation 710 to perform one or more particular inventory tasks. As such interactions occur, the workstation 710 may send the related interaction data to the training computer system 750. In response, this system 750 may update the training profile of the user.

Upon completion of a training module, the workstation 710 may also send completion data to the training computer system 750. The user's training profile may also be updated accordingly.

At time intervals (such as every five minutes after receiving the user ID, or based on API calls from the workstation 710), the training computer system 750 may access the updated training profile of the user to determine the training that has been completed, the inventory tasks that have been trained on, and other updates to generate additional sequences, each of which may indicate one or more additional training modules and one or more inventory tasks to trigger the presentation of such additional training modules. Here also, the training computer system 750 may send the additional sequences at the time intervals to the workstation 710, thereby continuously updating the workstation 710 with customized training of the user.

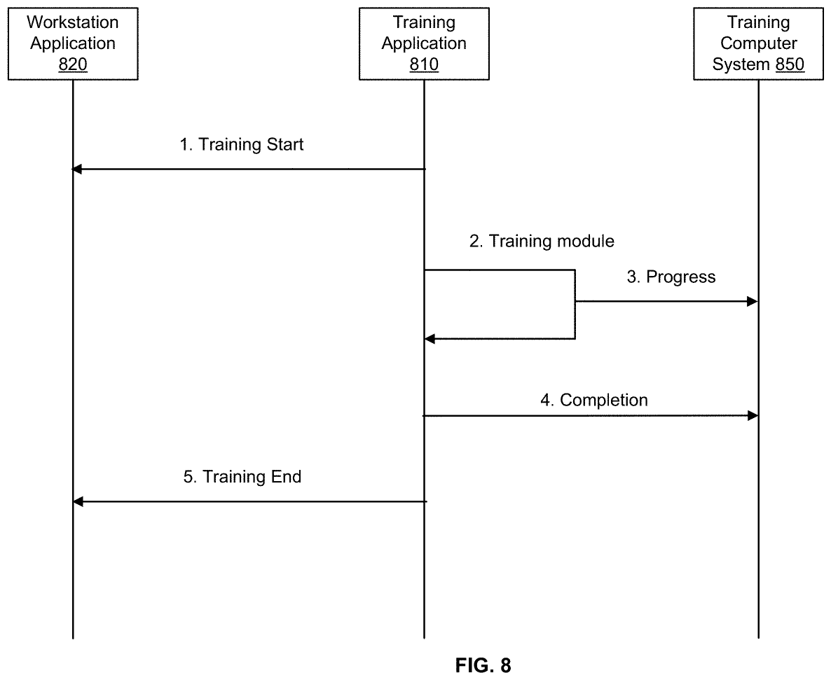

FIG. 8 illustrates a sequence diagram for introductory training, in accordance with at least one embodiment. As illustrated, a training application 810 may interface with a workstation application 820. Both applications 810 and 820 may be executed on a workstation.

In a first step, the training application 810 may send an event to the workstation application 820 indicating a start of the presentation of a training module. This event may be used by the workstation application 820 to present a graphical and/or audible indication to the user about the start and/or to interface with a production system for receiving items. The training application 810 may launch the presentation, where this module may be an introduction training module or a familiarization training module. The training module may be identified based on a trigger rule. The progress of the presentation, including any interactions of the user with the presented content, may be reported to the training computer system 850 to update the user's training profile. Upon completion of the training module, the training application 810 may report the completion to the training computer system 850 to also update the user's training profile. The reported data, whether for progress or completion, may identify the progress or completion as applicable, the user, the workstation, and/or the training module. This data may also include the specific status (pass/fail) as well as the user's score.

Upon completion, the training application 810 may also report the end of the training module to the workstation application 820.

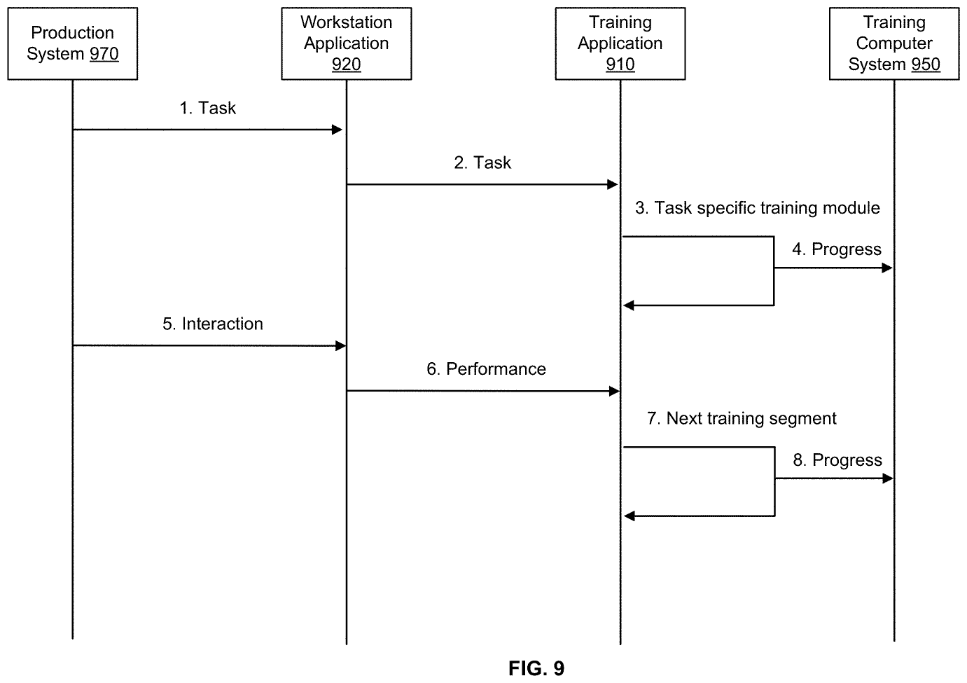

FIG. 9 illustrates a sequence diagram for a training related to a task or an action of the task, in accordance with at least one embodiment. As illustrated, a training application 910 may interface with a workstation application 920. Both applications 910 and 920 may be executed on a workstation. Either or both applications 910 and 920 may interface with a training computer system 950 and with a production system 970. The production system 970 may have scheduled an inventory task that should be initiated, controlled, or performed at the workstation. Based on the user's training profile, a training module specific to that task may have been received in a training sequence by the workstation 910 from the training computer system 950.

In a first step, the production system 970 may send a production event to the workstation application 920. This event may provide instructions about the scheduled inventory task. In turn, the workstation application 920 may send an application event identifying the task to the training application 910. Based on this task and triggers rules from available training module(s), the training application 910 may select a training module that includes one or more training segments specific to this task and may launch the presentation of this training module and/or one of the specific training segments. Progress about the presentation and user interactions therewith may be reported to the training computer system 950.

The user may then perform the inventory task by interacting with the workstation application 920. If the user interaction necessitated the use of the production system 970, the production system 970 may send data about the user interaction therewith (e.g., bin reach, container scan, item scan, item quantity scan) to the workstation application 920. In turn, this application 920 may compare the data to the instructions about the inventory task to determine the performance and may send event data to the training application 910. Based on an indicated success or failure, the training application 910 may select a next training segment from the training module for presentation. Progress about the presentation and user interactions therewith may be reported to the training computer system 950. The reported data may identify the progress, user, workstation, training module, the training segment, and/or user interactions.

The interactions between the training application 910, the workstation application 920, the production system 970 and the reporting to the training computer system 950 may be repeated to present various training modules and/or training segments available to the workstation from the training computer system 950 for different inventory tasks. Completion of the training modules may also be reported to the training computer system 950.

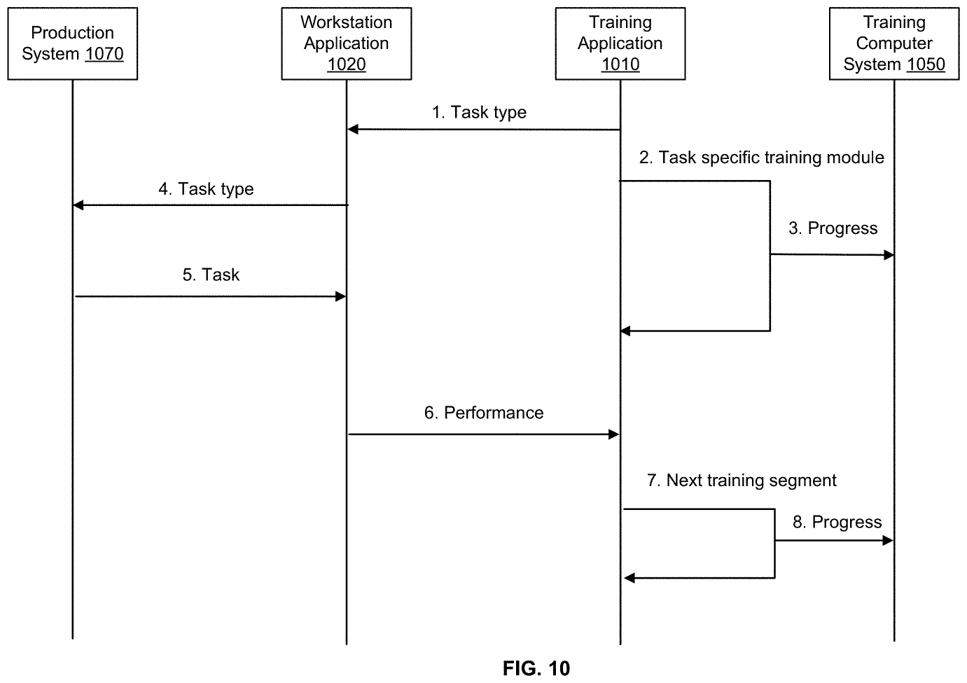

FIG. 10 illustrates a sequence diagram for a training related to a task or an action of the task, in accordance with at least one embodiment. This training may be provided in a production phase, similar to the production phase 170 of FIG. 1. As illustrated, a training application 1010 may interface with a workstation application 1020. Both applications 1010 and 1020 may be executed on a workstation. Either or both applications 1010 and 1020 may interface with a training computer system 1050 and with a production system 1070. The training application may launch a training module specific to a type of an inventory task that has not been scheduled by the production system 1070. To assist with this training, the type of this inventory task may be identified to the production system 1070 and this system 1070 may schedule it to occur with the launched training.

In a first step, the training application 1010 may send an application event to the workstation application identifying the type of the inventory task. Based on the user's training profile, a training module specific to that type may have been by the workstation from the training computer system 1050. Based on trigger rules, the presentation of the training module (or of a training segment within this module specific to the inventory task type) may be launched. Progress about the presentation and user interactions therewith may be reported to the training computer system 1050.

The workstation application 1020 may send a production event identifying the inventory task type to the production system 1070. Based on the type, the workstation 1010, the user, and inventory tasks to be performed within the inventory management facility, the production system 1070 may identify a particular task of the requested type and send instructions about the task to the workstation application. In addition, the production system 10170 may control various local systems based on the task. For instance, the task may be for picking a particular item from a particular bin in a particular inventory holder. Accordingly, a mobile drive unit may move the inventory holder to the workstation just in time for the training.

The user may then perform the inventory task by interacting with the workstation application 1020. If the user interaction necessitated the use of the production system 1070, the production system 1070 may send data about the user interaction therewith (e.g., bin reach, container scan, item scan, item quantity scan) to the workstation application 1020. In turn, this application 1020 may compare the data to the instructions about the inventory task to determine the performance and may send event data to the training application 1010. Based on an indicated success or failure, the training application 1010 may select a next training segment from the training module for presentation. Progress about the presentation and user interactions therewith may be reported to the training computer system 1050. The reported data may identify the progress, the user, the workstation, the training module, the training segment, user interactions, and/or the inventory task.

The interactions between the training application 1010, the workstation application 1020, the production system 1070 and the reporting to the training computer system 1050 may be repeated to schedule other types of inventory task and present various training modules and/or training segments available to the workstation from the training computer system 1050. Completions of the training modules may also be reported to the training computer system 1050.

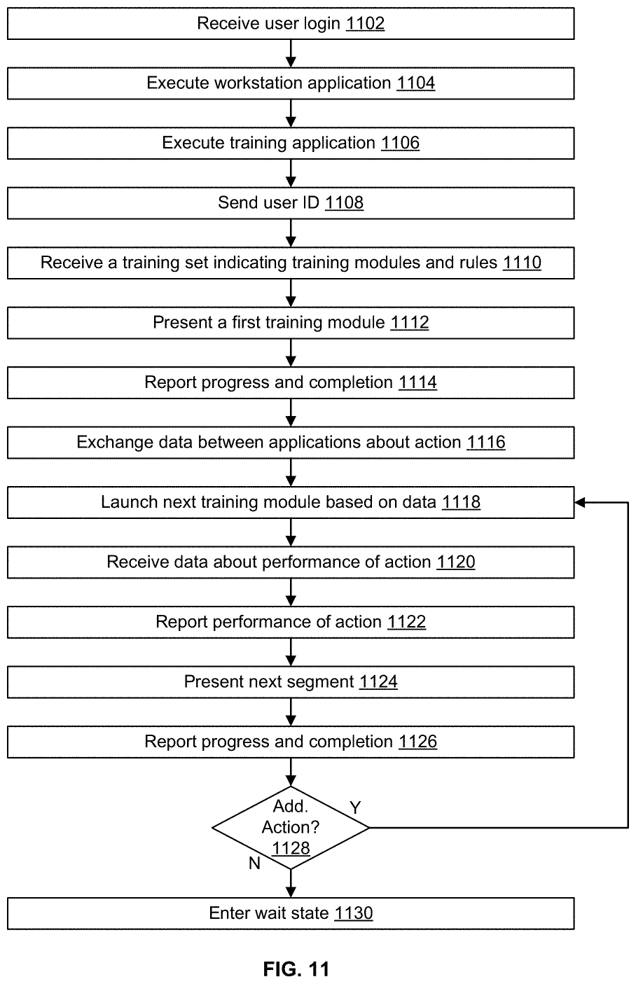

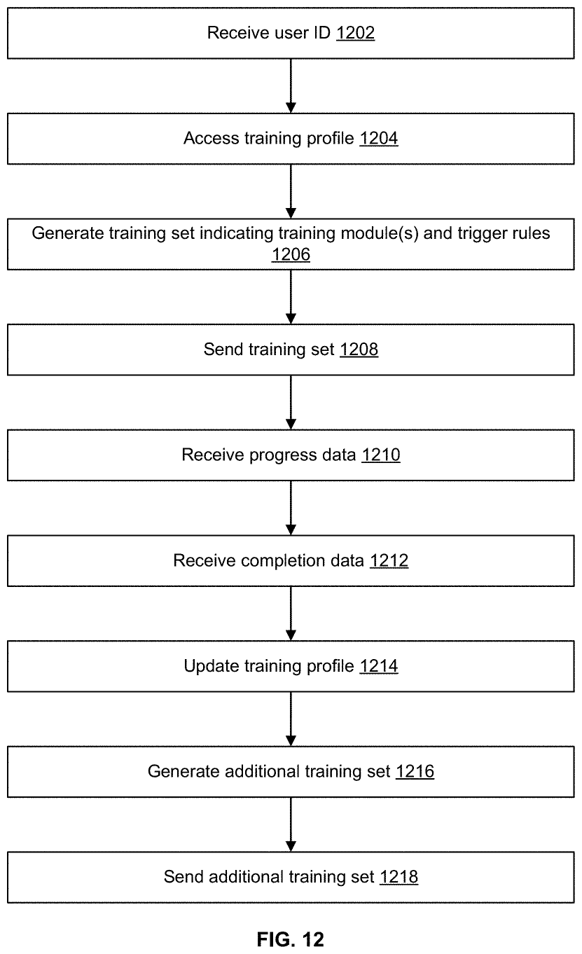

FIGS. 11-13 illustrate example flows for training a user of a workstation. A workstation, similar to the workstations 510 and 610 of FIGS. 5 and 6, is described as performing operations of the flow of FIGS. 11 and 13. A training computer system, similar to the training computer system 520 of FIG. 5, is described as performing operations of the flow of FIG. 12. Instructions for performing the operations can be stored as computer-readable instructions on non-transitory computer-readable media of such two computer systems. As stored, the instructions represent programmable modules that include code executable by one or more processors of the computer systems. The execution of such instructions configures each of the computer systems to perform the specific operations shown in the figures and described herein. Each programmable module in combination with the respective processor represents a means for performing a respective operation(s). While the operations are illustrated in a particular order, it should be understood that no particular order is necessary and that one or more operations may be omitted, skipped, and/or reordered.

In the interest of clarity of explanation, the example flows are illustrated with multiple training modules: an introduction training module to be presented in an introduction phase, a familiarization training module to be presented in a familiarization phase, and inventory task training modules to be presented in a production phase. Each of these modules may include multiple segments that have been indexed. These training modules segments may be available in a training sequence based on an enrollment of the user to receive the training. Of course, the example flows are applicable to other training modules. In addition, the example flows are described in connection with launching the inventory task training module based on the respective inventory task. However, the example flows similarly apply to launching any training module, where the launch may depend on different types of events (e.g., when a user selects an action button on the workstation application GUI, uses a help button on the GUI to explicitly request training after having started an action, or based on a default rule for selecting a particular training module, the relevant training module is launched).

FIG. 11 illustrates an example flow for live adaptive training, in accordance with at least one embodiment. The example flow is implemented on the workstation to train a user in a live and adaptive manner depending on actual production tasks and performance.

In an example, the flow of FIG. 11 may start at operation 1102, where the workstation may receive a user login. For example, the workstation may include a badge reader. Upon a user scan of their badge, the badge reader may read this badge and provide a user ID to the workstation.

At operation 1104, the workstation may execute a workstation application. In an example, the workstation application may be a workstation application, configured to instruct the user about inventory tasks (e.g., a pick application usable for item picking) and enabling the user to initiate, control, and/or perform such tasks. The workstation application may be automatically launched based on the user login.

At operation 1106, the workstation may execute a training application. In an example, the workstation application may initialize the training application based on contextual data about the user, the workstation, and/or the facility. The training application may be configured to retrieve the training modules from a content store and to present the training modules to the user. The presentation may rely on an overlay that covers at least some portion of a GUI of the workstation application. The overlay and the training segment to be presented as content in the overlay may be dynamically adapted based on data exchanges with the workstation application.

At operation 1108, the workstation may send the user ID to the training computer system. In an example, the user ID is sent by the training application in an API call or a web request.

At operation 1110, the workstation may receive a training set from the training computer system based on the user ID. In an example, the training set may identify a training module (e.g., its URL) and one or more triggers rules to select and launch the training module. In another example, the training set may include a training sequence that identifies multiple training modules and indicates the order in which they should be presented and their trigger rules. In both example, receiving a training module may include determining by the training application that a condition specified in a trigger rule of the training module is satisfied and retrieving by the training application the content of this training module from a data store based on the URL.

At operation 1112, the workstation may present a first training module. In an example, the training application may have received at operation 1110 an introduction training module or a familiarization training module and may present the received training module. In another example, multiple training modules may have been received at operation 1110, along with a training sequence. In this example, the training application may present the introduction training module first followed by the presentation of the familiarization training module based on presentation order indicated by the training sequence. Further, the training application may send an event to the workstation application indicating a start of the presentation. In response, the workstation may enter a standby mode and may interface with the production management system to coordinate inventory tasks (e.g., to prevent or delay a new inventory task until the presentation of the training module ends).

At operation 1114, the workstation may report progress and completion of the first training module to the training computer system. In an example, interactions of the user with the introduction training module may be tracked by the training application and sent, in batches or as detected, to the training computer system over APIs. In an example, the training computer system may determine the next training set and send an indication thereof to the workstation.

At operation 1116, a data exchange about an inventory task may occur between the workstation application and the training application. In an example, an item pick is scheduled by the production management system for the user at the workstation. In this case, the workstation application may send an application event to the training application indicating that a pick task is scheduled. In another example, an item pick may not have been scheduled yet by the production management system for the user at the workstation. Instead, given the training and the progress so far, the training application may determine that the next training module is for item picks, necessitating interactions with the workstation and underlying systems. The training application may send an application event to the workstation application indicating that training for item picks is about to start. The workstation application may in turn relay this information to the production management system that then schedules an item pick for the user at the workstation.

At operation 1118, the workstation launch a next training module. Different techniques are possible to select the next training module. In one example and based on the reported data at operation 1114, the training computer system may have indicated an inventory task training module to the training application along with one or more trigger rules. In this example, the training application may determine that this module should be launched based on the trigger rule(s) and the application event (e.g., based on a match between the scheduled inventory task indicated by the event and a trigger rule of the training module). Accordingly, the training application may receive and present the inventory task training module. In another example, the training computer system may have indicated a sequence of multiple training modules to the training allocation along with their respective triggers. In this case, the training application, rather than the training computer system, may determine the match and select the inventory task training module for launch. In yet another example, where the training application sent an event to the workstation application about a particular inventory task, the training application may have already selected the inventory task training module based on the training sequence and the training progress so far. Further different techniques for launching the training segment are possible. In an example, the training application starts with a presentation of the first training segment from this module. In another example, event data exists for the user and is associated with the inventory task. In this example, the segment may be selected from segments of the training module based on the event data.

At operation 1120, the workstation may receive data about the performance of the inventory task based on the presentation of the selected training module. In an example, the user may start interacting with the underlying systems (e.g., by reaching into a bin, scanning a container, scanning an item, etc.) and performance about such interactions may be sent to the workstation application. In turn, the workstation application may compare this data to the instructions about the scheduled inventory task to determine whether there are any successes or failures. The workstation application may send one or more application events to the training application indicating the success(es) and/or failures. In another example, the event data may be received from downstream systems and may indicate a quality measurement (e.g., quantity of items is incorrect at a frequency exceeding an acceptable threshold, indicating that the user may need better training about determining the quantity of item to pick). In yet another example, the user may additionally or alternatively be interacting with GUI action buttons of the workstation application. Data about such interactions may be sent to the training application.

At operation 1122, the workstation may report performance of the inventory task to the training system. For example, the event data about the interactions with the underlying systems and/or the workstation application may be sent to the training computer system to update the training profile of the user.

At operation 1124, the training application may present a next segment of the inventory training module based on the event data. In an example, the training module may include transition triggers indicating how the presentation of the training modules should progress based on the event data. In this example, the transition triggers may be transparent to the training application. In another example, metadata of the training module may include a set of rules (e.g., “if-then” rules) indicating how navigation between the segments should occur based on event data (e.g., move back from the presentation of fourth segment about pick and scan to the second segment about checking the item quantity if the event data indicates that the wrong item quantity was scanned). The training application may include a rule engine that selects the next segment based on this set of rules and the event data. The training application may then present the selected segment in the overlay.

At operation 1128, the training application may report progress and completion of the presentation of the training module. In an example, interactions of the user with the training module and the training segments, as applicable, may be tracked by the training application and sent, in batches or as detected, to the training computer system over APIs.

At operation 1128, the workstation may determine whether an additional inventory task may have been scheduled for the user. If so, the workstation may loop back to operation 1118 to select and launch a next training module applicable to that task. In an example, the workstation may receive from the training computer system additional training sets or sequences at time intervals, where these may depend on the training progress of the user. Hence, by looping back to operation 1118, the workstation may check for new training modules. Otherwise, operation 1134 may follow operation 1132.

At operation 1134, the training application may enter a wait state. In an example, the training application may monitor application events from the workstation application. If one of such events indicates a type of inventory task for which a training module has been received (based on a training enrollment), has not been presented yet, and its trigger rule indicates that it should be launched, the training application may launch this module. In another example, an application event may indicate the need to re-train the user on a previously trained inventory task. In this case, the training application may launch the applicable training module.

FIG. 12 illustrates an example flow for providing training modules in accordance with at least one embodiment. The example flow is implemented on the training computer system to generate training sequences for the user at the workstation over time.

In an example, the flow of FIG. 12 may start at operation 1202, where the training computer system may receive a user ID from the workstation. In an example, the user ID may be received in a web request or in an API call.

At operation 1204, the training computer system may access a training profile of the user based on the user ID. In an example, the training profile may include a history of the user's training.

At operation 1206, the training computer system may generate a training set. In an example, the training set may indicate at least one training module and applicable trigger rule(s). In another example, the training set includes a training sequence indicating training modules and applicable trigger rules. The training computer system may determine the inventory tasks that the user may have been trained on from the training profile and training enrollment of the user. The training computer system may also determine contextual data based on a profile of the workstation, inventory tasks that can be performed at the workstation. The training computer system may then generate the training set, where version(s) of the training module(s) may be specific to the contextual data.

At operation 1208, the training computer system may send the training set to the workstation. In an example, upon an API call from the workstation identifying a training module, the training computer system may send an identifier of a storage location of the training module (e.g., its URL) to the workstation. In addition, the training computer system may return metadata about the training module, such as user friendly course and module names, for display in a dropdown menu by the training application (e.g., in a table of contents under the dropdown menu),

At operation 1210, the training computer system may receive progress data from the workstation. In an example, the progress data may indicate how well the user is interacting with the training modules, segments therein, and/or underlying production systems.

At operation 1212, the training computer system may receive completion data. In an example, the completion data may indicate that a particular training module(s) was successfully presented to and completed by the user.

At operation 1214, the training computer system may update the training profile of the user based on the progress data and the completion data. In this way, a history of the user's training may be tracked.

At operation 1216, the training computer system may generate an additional training set, where this set may identify additional training module(s) and/or trigger rule(s). In an example, additional training sets may be generated and pushed to the workstation at predefined time intervals (e.g., every five minutes) or the workstation may pull these sets.

At operation 1218, the training computer system may send the additional training set to the workstation. In this way, the workstation may retrieve, at time intervals (e.g., every five minutes) additional training modules applicable based on the user's training progress.

FIG. 13 illustrates another example flow for live adaptive training, in accordance with at least one embodiment. The example flow of this figure may represent a particular implementation of the example flow of FIG. 11. As illustrated, the example flow of FIG. 13 starts at operation 1302, where a workstation application executed on a workstation initializes a training application. In an example, the initialization may be performed upon a user login to the workstation via a badge scan or input at a user interface. The initialization may include different parameters such as an identifier of the user (e.g., the user name, badge number, etc.), contextual data about the workstation, task at hand, the facility, etc.

At operation 1304, the training application may query a training computer system for user training. In an example, the training application may send the identifier of the user to training computer system and, optionally, some or all of the contextual data.

At operation 1306, the training application may receive a training set from the training computer system. In an example, the training set may identify one or more training modules and, optionally, one or more trigger rules per training module. A trigger rule(s) for a training module may also be stored in the training module. In a particular illustration, the training set may include one training module for each training course the user may be enrolled in and each of such modules may describe the next module to be delivered. Generally, the training computer system may define the training set based on a user enrollment and a user transcript (e.g., the user's training history including training accesses, failures, and performance) that correspond to the identifier of the user, where such enrollment and transcript may be stored in a training profile of the user. If contextual data is also sent to the training computer system, such data may be used in defining the training set (e.g., a version of a training module is identified based on an identifier or a type of the workstation, a training module applicable to a task at hand may be added to the training set, etc.). A trigger rule defined for a training module may specify one or more conditions. When the conditions are satisfied, the training module should be presented.

At operation 1308, the training application may determine whether, for at least one of the training modules identified in the training set, a trigger rule exists or not. If no trigger rule is identified in the training set for a training module, operation 1310 may follow operation 1308.

Otherwise, a trigger rule exists and operation 1312 may follow operation 1308.

At operation 1310, the training application may launch the training module for which no trigger rule is defined. In an example, the training module may be launched as soon as possible by sending a start event to the workstation application, requesting and receiving from the training computer system a network address of the content of the training module (e.g., the URL where the training segments and content metadata is stored), opening a window to present the training segments from the URL according to the content metadata, and overlay the window to partially or fully cover the GUI of the workstation application. The content metadata may include a description about the training module, such as the name of the corresponding course, the title of the training module, and titles of the training segments. Such information may be used to populate a table of contents presentable in the window in a dropdown menu. The content metadata may also define transition rules to transition between the training segments when presented. Some of the transitions may depend on user interactions with the training application, and/or on user interactions with and other events detected by the workstation application and passed to the training application. In addition, the content metadata may define parameters for the overlay (e.g., the size, any cutouts, transparency, etc.). As further described in connection with the next operations, user interactions with, progress through, and completion of the training module may be reported to the training computer system. The completion may also be reported as an end event to the workstation application.

At operation 1312, the training application may receive one or more application events from the workstation application. In an example, an application event may correspond to a user interaction with the workstation application (e.g., with this application's GUI). In another example, an application event may correspond to a task to be performed at the workstation, where the workstation application may receive data about this task from a production management system.

At operation 1314, the training application may determine whether a match may exist between a received application event and any of the trigger rule(s) received in the training set. In this way, a training module having a trigger rule may not be launched until the relevant event is detected. Determining the match may include comparing, by a rule engine of the training application, parameters of the application event to conditions specified in the trigger rule (e.g., a match exist when the application event and the trigger rule identify the same task). If no match exist, operation 1314 may loop back to operation 1312 for receiving and analyzing additional application events. Otherwise, operation 1316 may be performed. In an example, the training application may store the last application event received from the workstation application (e.g., as effectively a workstation application state). To determine whether a match exists to launch a training module, the last event may be used to check whether the workstation application is in the correct state. This may allow handling edge cases and broaden applicability by ensuring that the training module to present is relevant to the state of the workstation application (e.g., is relevant to an inventory task to be performed with the workstation application given the last application event received from this application).

At operation 1316, the training application may launch the training module. In an example, the launch may include sending a start event to the workstation application, requesting and receiving from the training computer system a network address of the content of the training module (e.g., the URL where the training segments and content metadata is stored), opening a window to present the training segments from the URL according to the content metadata, and overlay the window to partially or fully cover the GUI of the workstation application. Hence, the training application may the presentation of the training module by presenting a training segment (e.g., the initial training segment from the training module, any specific training segment identified according to the content metadata and/or the matched application event) in the window as an overlay over the GUI of the workstation application.

At operation 1318, the training application may present the training segments from the training window. In an example, the training segments are presented in the window. The transition between the training segments may depend on the defined transition rules of the training module. For instance, the training application may determine user interactions with the training application, and/or receive user interactions with the workstation application and/or event data of events detected by the workstation application. The transition rules can specify the order of presenting the training segments based on such user interactions and/or event data.

At operation 1320, the training application may report the user training data to the training computer system. In an example, the user interactions and the progress through the training module (e.g., including any answers to quizzes, successes, failures) may be sent along the identifier of the user to the training computer system.

At operation 1322, the training application may report the completion of the training module to the training computer system. The training application may also send an event to the workstation application. Upon completion, operation 1322 may loop back to operation 1308, where the training application may determine whether other training modules identified in the training set should be presented (based on trigger rules). Furthermore, at time intervals (e.g., every five minutes), operation 1304 may be repeated again, such that the training application may query and receive, as applicable, from the training computer system additional user training relevant to the user. In addition, operation 1304 may be performed immediately when a particular module is completed such that the user may not have to wait before the next module in sequence is launched, as applicable. In example, a push mechanism may be implemented, where the training computer system may push additional training modules while a training module is being presented or after that training module is completed.

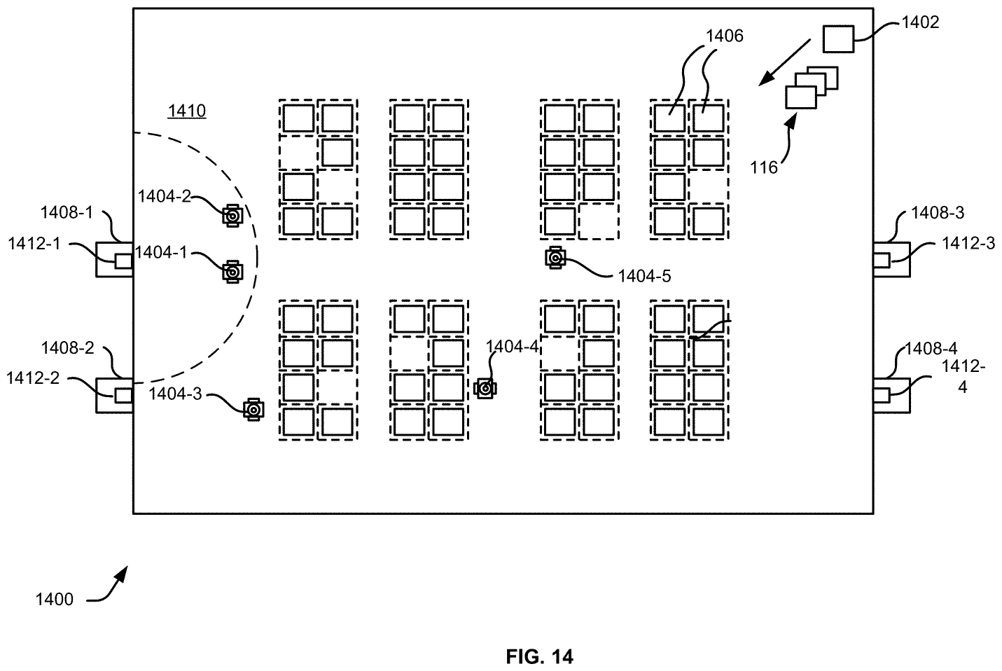

FIG. 14 illustrates an example environment suitable for implementing aspects of an inventory system 1400, in accordance with at least one embodiment. As a non-limiting example, the inventory system 1400 may include a management module 1402 (or a management system), one or more mobile drive units (e.g., mobile drive unit 1404-1, mobile drive unit 1404-2, mobile drive unit 1404-3, mobile drive unit 1404-4, and mobile drive unit 1404-5, collectively referred to as “mobile drive units 1404”), one or more storage containers (e.g., storage containers 1406), and one or more workstations (e.g., workstation 1408-1, workstation 1408-2, workstation 1408-3, workstation 1408-4, collectively referred to as “workstations 1408”). In some embodiments, workstations 1408 may include one or more controller devices (e.g., controller device 1412-1, controller device 1412-2, controller device 1412-3, and controller device 1412-4, collectively referred to as “controller devices 1412”). The mobile drive units 1404 may transport storage containers 1406 between points within a workspace 1410 (e.g., an inventory management facility, or the like) in response to commands communicated by management module 1402. While the management module 1402 is depicted in FIG. 14 as being separate from the mobile drive units 1404, it should be appreciated that the management module 1402, or at least some aspects of the management module 1402, may be additionally or alternatively be performed by a processor of the mobile drive units 1404. Within the inventory system 1400, each of the storage containers 1406 may store one or more types of inventory items. As a result, inventory system 1400 may be capable of moving inventory items between locations within the workspace 1410 to facilitate the entry, processing, and/or removal of inventory items from inventory system 1400 and the completion of other tasks involving inventory items.

In accordance with some embodiments, the management module 1402 may assign tasks to appropriate components of inventory system 1400 and may coordinate operations of the various components in completing the tasks. The management module 1402 may select components of inventory system 1400 (e.g., workstations 1408, mobile drive units 1404, and/or workstation operators (not depicted), etc.) to perform these tasks and communicate appropriate commands and/or data to the selected components to facilitate completion of these operations. In some embodiments, workstation operators may utilize a computing devices of a workstation such as a station computing device, a scanner, a smart device, or the like to receive such commands or exchange any suitable information with the management module 1402. Although shown in FIG. 14 as a single, discrete component, the management module 1402 may represent multiple components and may represent or include portions of the mobile drive units 1404 or other elements of the inventory system 1400. The components and operation of an example embodiment of management module 1402 are discussed further below with respect to FIG. 6.

The mobile drive units 1404 may move storage containers 1406 between locations within the workspace 1410. The mobile drive units 1404 may represent any devices or components appropriate to move (e.g., propel, pull, etc.) a storage container based on the characteristics and configuration of the storage containers 1406 and/or other elements of inventory system 1400. In a particular embodiment of inventory system 1400, the mobile drive units 1404 represent independent, self-powered devices configured to freely move about the workspace 1410. Examples of such inventory systems are disclosed in U.S. Pat. No. 9,087,314, issued on Jul. 21, 2015, titled “SYSTEM AND METHOD FOR POSITIONING A MOBILE DRIVE UNIT” and U.S. Pat. No. 8,280,547, issued on Oct. 2, 2012, titled “METHOD AND SYSTEM FOR TRANSPORTING INVENTORY ITEMS”, the entire disclosures of which are herein incorporated by reference. In alternative embodiments, the mobile drive units 1404 represent elements of a tracked inventory system configured to move the storage containers 1406 along tracks, rails, cables, crane system, or other guidance or support elements traversing the workspace 1410. In such an embodiment, the mobile drive units 1404 may receive power and/or support through a connection to the guidance elements, such as a powered rail. Additionally, in particular embodiments of the inventory system 1400 the mobile drive units 1404 may be configured to utilize alternative conveyance equipment to move within the workspace 1410 and/or between separate portions of the workspace 1410.

Additionally, the mobile drive units 1404 may be capable of communicating with the management module 1402 to receive information identifying selection of the storage containers 1406, transmit the locations of the mobile drive units 1404, or exchange any other suitable information to be used by the management module 1402 or the mobile drive units 1404 during operation. The mobile drive units 1404 may communicate with the management module 1402 wirelessly, using wired connections between the mobile drive units 1404 and the management module 1402, and/or in any other appropriate manner. As one example, particular embodiments of the mobile drive unit 20 may communicate with the management module 1402 and/or with one another using 802.11, Bluetooth, or Infrared Data Association (IrDA) standards, or any other appropriate wireless communication protocol. As another example, in a tracked inventory system 1400, tracks or other guidance elements upon which the mobile drive units 1404 move may be wired to facilitate communication between the mobile drive units 1404 and other components of the inventory system 1400. In general, the mobile drive units 1404 may be powered, propelled, and controlled in any manner appropriate based on the configuration and characteristics of the inventory system 1400.

In at least one embodiment, the storage containers 1406 store inventory items. The storage containers 1406 are capable of being carried, rolled, and/or otherwise moved by the mobile drive units 1404. In some embodiments, the storage containers 1406 may include a plurality of faces, and each storage component (e.g., a bin, a tray, a shelf, an alcove, etc.) may be accessible through one or more faces of the storage container 1406. The mobile drive units 1404 may be configured to rotate the storage containers 1406 at appropriate times to present a particular face to an operator (e.g., human personnel) or other components of the inventory system 1400.

In at least one embodiment, inventory items represent any objects suitable for storage, retrieval, and/or processing in an automated inventory system 1400. For the purposes of this description, “inventory items” (also referred to as “items” or “an item”) may represent any one or more objects of a particular type that are stored in the inventory system 1400. In at least one example, the inventory system 1400 may represent a mail order warehouse facility (e.g., operated by an electronic marketplace provider), and the items within the warehouse facility may represent merchandise stored in the warehouse facility. As a non-limiting example, the mobile drive units 1404 may retrieve the storage containers 1406 containing one or more inventory items requested in an order to be packed for delivery to a customer. Moreover, in some embodiments of the inventory system 1400, boxes containing completed orders may themselves represent inventory items.

In particular embodiments, the inventory system 1400 may also include one or more workstations 1408. The workstations 1408 represent one or more systems at locations designated for the completion of particular tasks involving inventory items. Such tasks may include the removal of inventory items from the storage containers 1406, the introduction of inventory items into the storage containers 1406, the counting of inventory items in the storage containers 1406, the decomposition of inventory items (e.g. from pallet- or case-sized groups to individual inventory items), the consolidation of inventory items between the storage containers 1406, and/or the processing or handling of inventory items in any other suitable manner. Equipment of the workstations 308 for processing or handling inventory items may include as robotic devices (e.g., robotic arms), scanners for monitoring the flow of inventory items in and out of the inventory system 1400, communication interfaces for communicating with the management module 1402, and/or any other suitable components. The workstations 1408 may be controlled, entirely or in part, by human operators or may be fully automated. Moreover, the human personnel and/or robotic devices of the workstations 1408 may be capable of performing certain tasks involving inventory items, such as packing, counting, or transferring inventory items, as part of the operation of the inventory system 1400.

In at least one embodiment, the workspace 1410 represents an area associated with the inventory system 1400 in which the mobile drive units 1404 can move and/or the storage containers 1406 can be stored. For example, the workspace 1410 may represent all or part of the floor of a mail-order warehouse in which the inventory system 1400 operates. Although FIG. 14 shows, for the purposes of illustration, an embodiment of the inventory system 1400 in which the workspace 1410 includes a fixed, predetermined, and finite physical space, particular embodiments of the inventory system 1400 may include the mobile drive units 1404 and the storage containers 1406 that are configured to operate within the workspace 1410 that is of variable dimensions and/or an arbitrary geometry. While FIG. 14 illustrates a particular embodiment of the inventory system 1400 in which the workspace 1410 is entirely enclosed in a building, alternative embodiments may utilize the workspace 1410 in which some or all of the workspace 1410 is located outdoors, within a vehicle (such as a cargo ship), or otherwise unconstrained by any fixed structure.

In operation, the management module 1402 may select appropriate components to complete particular tasks and may transmit task assignments 1416 to the selected components to trigger completion of the relevant tasks. Each of the task assignments 1416 defines one or more tasks to be completed by a particular component. These tasks may represent inventory tasks relating to the retrieval, storage, replenishment, and counting of inventory items and/or the management of the mobile drive units 1404, the storage containers 1406, the workstations 1408, workstation operators, and/or other components of the inventory system 1400. Depending on the component and the task to be completed, a task assignment may identify locations, components, and/or actions/commands associated with the corresponding task and/or any other appropriate information to be used by the relevant component in completing the assigned task.

In particular embodiments, the management module 1402 may generate task assignments 1416 based, in part, on inventory requests that the management module 1402 receives from other components of the inventory system 1400 and/or from external components in communication with the management module 1402. These inventory requests identify particular operations to be completed involving inventory items stored or to be stored within the inventory system 1400 and may represent communication of any suitable form. For example, in particular embodiments, an inventory request may represent a shipping order specifying particular inventory items that have been purchased by a customer and that are to be retrieved from the inventory system 1400 for shipment to the customer. After generating one or more of the task assignments 1416, the management module 1402 may transmit the generated task assignments 1416 to appropriate components (e.g., mobile drive units 1404, the workstations 1408, corresponding operators, etc.) for completion of the corresponding task. The relevant components may then execute their assigned tasks.

With respect to the mobile drive units 1404 specifically, the management module 1402 may, in particular embodiments, communicate task assignments 1416 to selected mobile drive units 1404 that identify one or more destinations for the selected mobile drive units 1404. The management module 1402 may select a mobile drive unit (e.g., mobile drive unit 1404-1) to assign the relevant task based on the location or state of the selected mobile drive unit, an indication that the selected mobile drive unit has completed a previously-assigned task, a predetermined schedule, and/or any other suitable consideration. These destinations may be associated with an inventory request the management module 1402 is executing or a management objective the management module 1402 is attempting to fulfill. For example, the task assignment may define the location of a storage container 1406 to be retrieved, a workstation to be visited (e.g., workstation 1408-1), or a location associated with any other task appropriate based on the configuration, characteristics, and/or state of inventory system 1400, as a whole, or individual components of the inventory system 1400.

As part of completing these tasks the mobile drive units 1404 may dock with and transport the storage containers 1406 within the workspace 1410. The mobile drive units 1404 may dock with the storage containers 1406 by connecting to, lifting, and/or otherwise interacting with the storage containers 1406 in any other suitable manner so that, when docked, the mobile drive units 1404 are coupled to and/or support the storage containers 1406 and can move the storage containers 1406 within the workspace 1410. The mobile drive units 1404 and storage containers 1406 may be configured to dock in any manner suitable to allow a mobile drive unit to move a storage container within workspace 1410. In some embodiments, the mobile drive units 1404 represent all or portions of the storage containers 1406. In such embodiments, the mobile drive units 1404 may not dock with the storage containers 1406 before transporting the storage containers 1406 and/or the mobile drive units 1404 may each remain continually docked with a storage container.

In some embodiments, the management module 1402 may be configured to communicate the task assignments 1416 to the workstations 1408 to instruct those components (and/or robotic devices and/or operators of the workstations 1408) to perform one or more tasks. The mobile drive units 1404 and/or station computing devices of the workstations 1408 may individually be configured to provide task performance information to the management module 1402. Task performance information may include any suitable data related to the performance of an assigned task. By way of example, a mobile drive unit may send task performance information to the management module 1402 indicating that the task of moving a particular storage container to a particular workstation has been completed. A station computing device may transmit task performance information to the management module 1402 indicating that an item has been placed in or removed from the selected storage container. Generally, any suitable information associated with task performance (e.g., a task identifier, a time of completion, an error code or other indication that the task was unsuccessful, a reason code or other indication as to why task performance was unsuccessful, etc.) may be provided as part of the task performance information.

While the appropriate components of inventory system 1400 complete assigned tasks, the management module 1402 may interact with the relevant components to ensure the efficient use of space, equipment, manpower, and other resources available to inventory system 1400. As one specific example of such interaction, management module 1402 is responsible, in particular embodiments, for planning the paths the mobile drive units 1404 take when moving within the workspace 1410 and for allocating use of a particular portion of the workspace 1410 to a particular mobile drive units 1404 for purposes of completing an assigned task. In such embodiments, the mobile drive units 1404 may, in response to being assigned a task, request a path to a particular destination associated with the task.

Components of the inventory system 1400 (e.g., the mobile drive units 1404, and/or the station computing devices of the workstations 1408, and/or controller device(s) 1412) may provide information to the management module 1402 regarding their current state, other components of the inventory system 1400 with which they are interacting, and/or other conditions relevant to the operation of the inventory system 1400. This may allow the management module 1402 to utilize feedback from the relevant components to update algorithm parameters, adjust policies, or otherwise modify its decision-making to respond to changes in operating conditions or the occurrence of particular events.

In addition, while the management module 1402 may be configured to manage various aspects of the operation of the components of the inventory system 1400, in particular embodiments, the components themselves may also be responsible for decision-making relating to certain aspects of their operation, thereby reducing the processing load on the management module 1402.

Thus, based on its knowledge of the location, current state, and/or other characteristics of the various components of the inventory system 1400 and an awareness of all the tasks currently being completed, the management module 1402 can generate tasks, allot usage of system resources, and otherwise direct the completion of tasks by the individual components in a manner that optimizes operation from a system-wide perspective. Moreover, by relying on a combination of both centralized, system-wide management and localized, component-specific decision-making (such as the techniques provided by the controller device(s) 1412 as discussed herein), particular embodiments of the inventory system 1400 may be able to support a number of techniques for efficiently executing various aspects of the operation of the inventory system 1400. As a result, particular embodiments of the management module 1402 may, by implementing one or more management techniques described below, enhance the efficiency of the inventory system 1400 and/or provide other operational benefits.

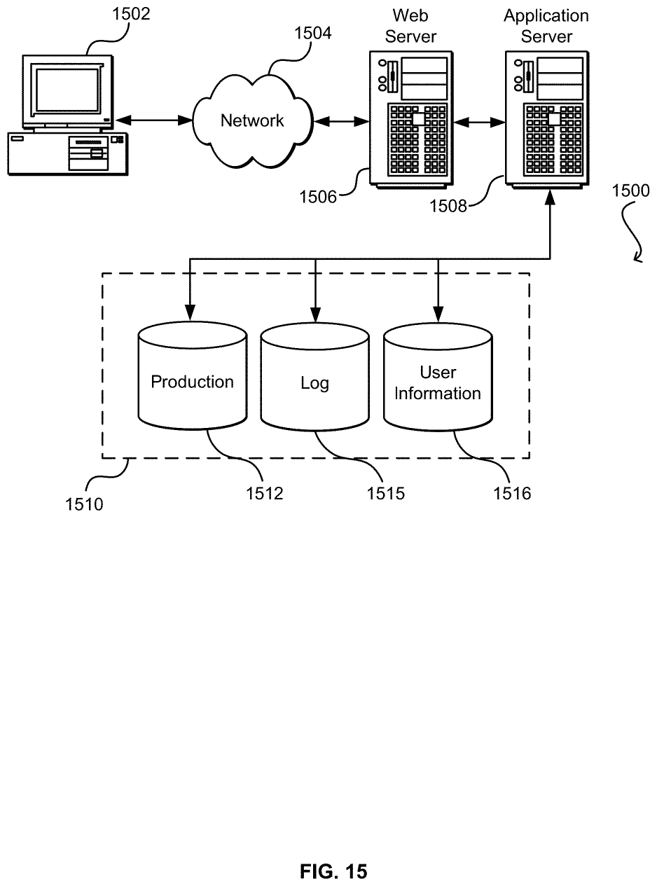

FIG. 15 illustrates a computer architecture diagram showing an example computer architecture, according to an embodiment of the present disclosure. This architecture may be used to implement some or all of the systems described herein. The computer architecture shown in FIG. 15 illustrates a server computer, workstation, desktop computer, laptop, tablet, network appliance, personal digital assistant (“PDA”), e-reader, digital cellular phone, or other computing device, and may be utilized to execute any aspects of the software components presented herein.

The computer 1500 includes a baseboard 1502, or “motherboard,” which is a printed circuit board to which a multitude of components or devices may be connected by way of a system bus or other electrical communication paths. In one illustrative embodiment, one or more central processing units (“CPUs”) 1504 operate in conjunction with a chipset 1506. The CPUs 1504 may be standard programmable processors that perform arithmetic and logical operations necessary for the operation of the computer 1500.

The CPUs 1504 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 1506 provides an interface between the CPUs 1504 and the remainder of the components and devices on the baseboard 1502. The chipset 1506 may provide an interface to a random access memory (“RAM”) 1508, used as the main memory in the computer 1500. The chipset 1506 may further provide an interface to a computer-readable storage medium such as a read-only memory (“ROM”) 1510 or non-volatile RAM (“NVRAM”) for storing basic routines that help to startup the computer 1500 and to transfer information between the various components and devices. The ROM 1510 or NVRAM may also store other software components necessary for the operation of the computer 1500 in accordance with the embodiments described herein.

The computer 1500 may operate in a networked environment using logical connections to remote computing devices and computer systems through a network, such as the local area network 1520. The chipset 1506 may include functionality for providing network connectivity through a NIC 1512, such as a gigabit Ethernet adapter. The NIC 1512 is capable of connecting the computer 1500 to other computing devices over the network 1520. It should be appreciated that multiple NICs 1512 may be present in the computer 1500, connecting the computer to other types of networks and remote computer systems.

The computer 1500 may be connected to a mass storage device 1518 that provides non-volatile storage for the computer. The mass storage device 1518 may store system programs, application programs, other program modules, and data, which have been described in greater detail herein. The mass storage device 1518 may be connected to the computer 1500 through a storage controller 1514 connected to the chipset 1506. The mass storage device 1518 may consist of one or more physical storage units. The storage controller 1514 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1500 may store data on the mass storage device 1518 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 1518 is characterized as primary or secondary storage, and the like.

For example, the computer 1500 may store information to the mass storage device 1518 by issuing instructions through the storage controller 1514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1500 may further read information from the mass storage device 1518 by detecting the physical states or characteristics of one or more particular locations within the physical storage units.

In addition to the mass storage device 1518 described above, the computer 1500 may have access to other computer-readable storage media to store and retrieve information, such as program modules, data structures, or other data. It should be appreciated by those skilled in the art that computer-readable storage media can be any available media that provides for the storage of non-transitory data and that may be accessed by the computer 1500.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM

(“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 1518 may store an operating system 1530 utilized to control the operation of the computer 1500. According to one embodiment, the operating system comprises the LINUX operating system. According to another embodiment, the operating system comprises the WINDOWS® SERVER operating system from MICROSOFT Corporation.

According to further embodiments, the operating system may comprise the UNIX or SOLARIS operating systems. It should be appreciated that other operating systems may also be utilized. The mass storage device 1518 may store other system or application programs and data utilized by the computer 1500. The mass storage device 1518 might also store other programs and data not specifically identified herein.

In one embodiment, the mass storage device 1518 or other computer-readable storage media is encoded with computer-executable instructions which, when loaded into the computer 1500, transforms the computer from a general-purpose computing system into a special-purpose computer capable of implementing the embodiments described herein. These computer-executable instructions transform the computer 1500 by specifying how the CPUs 1504 transition between states, as described above. According to one embodiment, the computer 1500 has access to computer-readable storage media storing computer-executable instructions which, when executed by the computer 1500, perform the various routines described above. The computer 1500 might also include computer-readable storage media for performing any of the other computer-implemented operations described herein.

The computer 1500 may also include one or more input/output controllers 1516 for receiving and processing input from a number of input devices, such as a keyboard, a mouse, a touchpad, a touch screen, an electronic stylus, or other type of input device. Similarly, the input/output controller 1516 may provide output to a display, such as a computer monitor, a flat-panel display, a digital projector, a printer, a plotter, or other type of output device. It will be appreciated that the computer 1500 may not include all of the components shown in FIG. 15, may include other components that are not explicitly shown in FIG. 15, or may utilize an architecture completely different than that shown in FIG. 15. It should also be appreciated that many computers, such as the computer 1500, might be utilized in combination to embody aspects of the various technologies disclosed herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A system for real-time and adaptive user training, comprising:
a workstation in an inventory management facility;
a central computer configured to provide instructions about inventory tasks associated with items in the inventory management facility;
a training computer system configured to provide user training,
the workstation comprising a workstation control system that comprise one or more processors and one or more memories storing computer-readable instructions that, upon execution by the one or more processors, configure the workstation control system to:
execute a workstation application associated with instructing, in a graphical user interface (GUI) of the workstation application, a user of the workstation about inventory tasks based at least in part on the instructions of the central computer; and
execute a training application associated with presenting the training modules, the training application configured to: query the training computer system for the user training based at least in part on an identifier of the user;
receive, from the training computer system based at least in part on a training enrollment and a training transcript corresponding to the identifier of the user, an identifier of a training module and a trigger rule to present the training module;
receive, from the workstation application, an event associated with the instructing of the user;
determine a match between the event and the trigger rule of the training module;
launch the training module based at least in part on the request, wherein the launch comprises requesting and receiving from the training computer system, a network address of the training module;
open a window configured to present the training module based at least in part on the network address, the window presented in an overlay that covers, at least partially, the GUI of the workstation application.

2. The system of claim 1, wherein the training application is further configured to:
receive a second identifier of a second training module; and
launch, prior to receiving the event, the second training module based at least in part on a determination that the second training module lacks a defined trigger rule specific to the second training module.

3. The system of claim 1, wherein the training application is initialized by the workstation application, presentation of the training module comprises a transition from a first training segment to a second training segment, wherein the transition is based at least in part on a second event received from the workstation application.

4. The system of claim 1, wherein the training application is further configured to:
report user interactions with and completion of the training module to the training computer system; and
query, at predefined time intervals, the training computer system for additional user training.

5. A computer-implemented method, comprising:
receiving, by a training application executed on a workstation and based at least in part on an identifier of a user of the workstation, a training module and a trigger rule to present the training module;
exchanging, by the training application, data with a workstation application executed on the workstation, the data about an event determined by the workstation application;
determining, by the training application, a match between the trigger rule and the event; and
initiating, by the training application, a presentation of the training module based at least in part on the match.

6. The computer-implemented method of claim 5, wherein the training application is initialized by the workstation application, wherein the training is received based at least in part on a training enrollment and a training transcript corresponding to the identifier of the user, wherein initiating the presentation comprises launching the training module in a window based at least in part on a network address of the training module, and wherein the window is presented in an overlay that covers, at least partially, a graphical user interface of the workstation application.

7. The computer-implemented method of claim 5, wherein the training module is presented in an overlay that covers action buttons from a graphical user interface of the workstation application, wherein the overlay comprises a user selectable button to navigate between segments of the training module.

8. The computer-implemented method of claim 5, wherein initiating the presentation of the training module comprises sending second data to the workstation application indicating a start of the presentation.

9. The computer-implemented method of claim 5, wherein the training module comprises a training segment about an action button of a graphical user interface of the workstation application, wherein the training segment is presented in an overlay that exposes the action button to the user and covers one or more remaining action buttons of the graphical user interface of the workstation application.

10. The computer-implemented method of claim 5, wherein the training application has an application programming interface (API) configured to receive a definition of a content author about a cutout in a canvas presented, by the training application, in an overlay over a graphical user interface of the workstation application.

11. The computer-implemented method of claim 5, further comprising:
providing, the training application to a training computer system, contextual data about at least one of the user, the workstation, or a facility that includes the workstation, wherein the training module is received from the training application further based at least in part on the contextual data.

12. The computer-implemented method of claim 5, wherein the presentation of the training module comprises a transition between training segments of the training module, wherein the transition is based at least in part on a second event determined by the workstation application.

13. The computer-implemented method of claim 5, wherein the event is associated with a task to be performed by the user based at least in part on the workstation application, wherein the data about the event is received, by the training application from the workstation application, based at least in part on a schedule for the task.

14. One or more computer-readable storage media comprising instructions that, upon execution on a workstation, cause the workstation to perform operations comprising:
executing a workstation application; and
executing a training application that interfaces with the workstation application, the training application:
receiving, based at least in part on an identifier of a user of the workstation, a training module and a trigger rule to present the training module;
exchanging data with the workstation application about an event determined by the workstation application;
determining a match between the trigger rule and the event; and
initiating a presentation of the training module based at least in part on the match.

15. The one or more computer-readable storage media of claim 14, wherein the operations further comprise:
sending the identifier of the user to a training computer system based at least in part on a badge scan or a user login on the workstation, wherein the training module is received from the training computer system based at least in part on a training enrollment and a training transcript corresponding to the identifier of the user and on contextual data.

16. The one or more computer-readable storage media of claim 15, wherein the training module has a version, and wherein the version is based at least in part on an identifier of the workstation.

17. The one or more computer-readable storage media of claim 14, wherein the event is associated with a task to be performed by the user at the work station, wherein the training module comprises a plurality of training segments about the task, wherein the presentation of the training module is initiated by presenting a first training segment, and wherein the presentation of the training module transitions to a second segment based at least in part on a second event detected by the workstation application about a performance of the task.

18. The one or more computer-readable storage media of claim 14, wherein the event is associated with a user interaction with a graphical user interface of the workstation application.

19. The one or more computer-readable storage media of claim 14, wherein the operations further comprise:
receiving, from a management system, a performance measurement of the user, wherein the performance measurement is associated with the event, wherein the training application re-initiates a presentation of the training module based at least in part on the performance measurement.

20. The one or more computer-readable storage media of claim 14, wherein the operations further comprise:
determining a frequency of presenting the training module based at least in part on the identifier of the user; and
sending an event to a computing device of a second user, the event requesting help.
